(19) United States
(12) Patent Application Publication
(10) Pub. No.: US 2025/0270140 A1
(43) Pub. Date: Aug. 28, 2025

(54) POLYMER-SILICATE ADMIXTURE SYSTEM AND METHOD

(71) Applicant: Purdue Research Foundation, West Lafayette, IN (US)

(72) Inventors: Kendra Ann Erk, West Lafayette, IN (US); John Alan Howarter, West Lafayette, IN (US); Akul Nimish Seshadri, Woodbury, MN (US); Alec Zielinski Lucas, Evanston, IL (US)

(21) Appl. No.: 19/060,199

(22) Filed: Feb. 21, 2025

Related U.S. Application Data
(60) Provisional application No. 63/556,548, filed on Feb. 22, 2024.

(51) Int. Cl. C04B 24/26; C04B 22/14; C04B 24/42; C04B 28/04; C04B 28/24; C04B 103/00

(52) U.S. Cl. CPC C04B 24/2652; C04B 22/147; C04B 24/42; C04B 28/04; C04B 28/24; C04B 2103/0062

(57) ABSTRACT

This disclosure relates to polymers that are useful in the chemical arts, such as in the manufacture of products, such as cementitious and cement-like compositions. In particular, the present disclosure relates to compositions and methods for preparing certain organic-inorganic composites, such as polymer-silicate admixtures.

### RELATED APPLICATIONS

This application claims the benefit of U.S. Provisional Application No. 63/556,548, filed Feb. 22, 2024, the entire disclosure of which is incorporated herein by reference.

### TECHNICAL FIELD

This disclosure relates to polymers that are useful in the chemical arts, such as in the manufacture of products, such as cementitious and cement-like compositions. In particular, the present disclosure relates to compositions and methods for preparing certain organic-inorganic composites, such as polymer-silicate admixtures.

### BACKGROUND

Concrete is the most widely used material on earth after water, and necessary for global infrastructure. However, ordinary Portland cement production accounts for roughly 8% of global carbon emissions. Research aimed at increasing cement durability and longevity is of increasing importance in the face of climate change, growing populations, and infrastructure demands. Development of polymeric admixtures over the last several decades have been pivotal in increasing the utility and durability of concrete. For example, polymeric admixtures for air entraining, viscosity modifying, and curing have become ubiquitous in the modern cement industry due to superior material properties and performance. Furthermore, experts agree that increased research and development in multifunctional, organic, admixtures are crucial for coming global infrastructure needs. Over the last two decades, researchers have investigated the use of superabsorbent polymer (SAP) hydrogels for applications in cement, mortar, and concrete. Hydrogels can strengthen cement as internal curing agents that mitigate autogenous shrinkage, increase freeze-thaw resistance, and even heal cracks.

Understanding the relationship between organic molecules and the primary building blocks of cement is important to the development of polymeric admixtures and improvement of cement. Calcium Silicate Hydrate (C-S-H) is the main strengthening phase of cement and largely responsible for its mechanical properties. C-S-H is a poorly-crystalline, layered, hydrated mineral structure made of silica, calcium hydroxide, and ionically bound water that exhibits a variety of morphologies including needlelike, fibrous, globular, honeycomb, among others. These varying morphologies are a result of many variables including free volume, cement chemistry, temperature, water content, and admixtures. Much research is devoted to understanding C-S-H structure and promoting its development to strengthen cement through a variety of methods including organic, biological, bio-inspired, and inorganic additives. Subsequently, other work is interested in increasing C-S-H growth and cement strength through the addition of synthesized C-S-H seeds or silica additives.

A common class of materials found in C-S-H synthesis, cement repair, and cement additive research are alkoxysilanes and silane coupling agents. These compounds are classified by a silicon bonded with alkoxy groups in the form Si—O—R. Under both acidic and basic conditions, alkoxysilanes hydrolyze: alkoxy groups are replaced by hydroxyls, creating silanol moieties. Following hydrolysis, silanol compounds condense into random networks of siloxane (Si—O—Si) bonds.

The necessity of increasing concrete strength led to the development of high-performance concrete (HPC) that exhibits a denser microstructure and superior mechanical properties due to its lower water content. However, the lack of water in HPC leads to self-desiccation as the cement cures, producing high capillary pressures leading to autogenous shrinkage and cracking. A small dosage of dry SAP hydrogel particles (˜0.2% by weight of cement) can effectively mitigate autogenous shrinkage of HPC by acting as an internal curing agent that releases its water via osmotic pressure to fuel cement hydration and curing reactions.

However, de-swelled SAP particles leave large macrovoids in the cement microstructure, approaching hundreds of microns in diameter. If too numerous, these macrovoids can reduce the mechanical strength and durability of concrete and could pose a challenge for specialized concrete geometries and applications.

The effects of varying SAP chemistry and composition on cementitious mixtures have been investigated. Changing the anionic nature of SAP through varying the ratio of acrylamide and acrylic acid monomer led to changes in the swelling capacity, interactions with multivalent cations in cement paste, and promotion of calcium hydroxide formation. Prior work investigated incorporating pozzolanic silica particles into SAP to encourage C-S-H nucleation and reduction of macrovoid formation. Recent work incorporated commercial nano-C-S-H directly into SAP.

The resulting inorganic-organic “composite” gel was able to mitigate autogenous shrinkage, increase the formation of hydration products, and reduce the number and size of macrovoids.

There is increased interest in organic and bioinspired additives for cement and early-age structuration and rheology of cementitious systems for 3D-printing applications. Unfortunately, hydrated, early-age, interactions between hydrogels and cement are rarely observed directly.

Accordingly, there remains a need for improved admixtures for use in the preparation of cementitious and cement-like compositions including cement and concrete.

### SUMMARY

In one aspect, the present disclosure provides an organic-inorganic composite comprising: an acrylic polymer; a siloxane; and a crosslinker, wherein the crosslinker interconnects the siloxane and the acrylic polymer to form the composite. In some embodiments, the crosslinker comprises an acrylic group that forms a portion of the acrylic polymer and a silicon atom that forms a portion of the siloxane.

In another aspect, the present disclosure provides a method of preparing the organic-inorganic composite of the present disclosure comprising: contacting a monomer mixture with an initiator. In some embodiments, the monomer mixture comprises a crosslinking monomer and an acrylic monomer.

In another aspect, the disclosure provides a cementitious composition comprising: the organic-inorganic of the present disclosure, and a cementitious material.

In another aspect, the disclosure provides a method of preparing a cementitious composition comprising: combining an organic-inorganic composite of the present disclosure and a cementitious material. In another aspect, the disclosure provides a method of preparing a cementitious composition comprising: providing an organic-inorganic composite of the present disclosure; and combining the composite and a cementitious material.

In another aspect, the disclosure provides a package comprising the organic-inorganic composite of the present disclosure.

In another aspect, the disclosure provides a package comprising the cementitious composition of the present disclosure.

Additional embodiments, features, and advantages of the disclosure will be apparent from the following detailed description and through practice of the disclosure. The compounds, compositions, and methods of the present disclosure can be described as embodiments in any of the following enumerated clauses. It will be understood that any of the embodiments described herein can be used in connection with any other embodiments described herein to the extent that the embodiments do not contradict one another.

### BRIEF DESCRIPTIONS OF THE DRAWINGS

The detailed description particularly refers to the accompanying figures.

FIG. 1 shows the chemical structures of monomers used in the hydrogel synthesis. The hydrogels were composed of polyacrylamide with MBAM as the organic crosslinker and TPM as the organic-inorganic crosslinker. The alkene group on the organic end of TPM allows it to be polymerized through free radical polymerization while the Si end undergoes hydrolysis in water, releasing the methyl (CH3) groups and forming siloxane bonds with nearby TPM molecules.

FIG. 2 shows a schematic representation of the different hydrogel chemistries and siloxane crosslinks.

FIG. 3 shows images of as-synthesized gels in 20 mL scintillation vials. Stir bars suspended in gelled solutions. Linear, uncrosslinked polyacrylamide (PAM) also included for reference.

FIGS. 4A and 4B shows FTIR spectra for the 5 gel compositions swelled with water. FIG. 4A shows FTIR spectra for wet MBAM and MBAM+ TPM crosslinked gels, and FIG. 4B shows FTIR spectra for TPM crosslinked gels. Linear PAM included for reference. NH (3350 cm⁻¹ and 1667 cm⁻¹) and siloxane (1057 cm⁻¹) peaks labeled.

FIG. 5A and 5B show SAXS patterns for the hydrogel samples. FIG. 5A shows SAXS patterns for (a) 2% MBAM and MBAM+TPM (2% MBAM 5% TPM and 2% MBAM 20% TPM) crosslinked gels, and FIG. 5B shows SAXS patterns for 5% TPM and 20% TPM crosslinked gels.

FIG. 6 shows a graph of oscillatory G′ and G′ measurements for gelling solutions of 5% TPM and 20% TPM gels.

FIG. 7 shows images of 2% MBAM, 2% MBAM 5% TPM, and two differently stirred 2% MBAM 20% TPM gels before and after cement pore solution diffusion.

FIG. 8 shows hydrogels before and 7 days after addition of super saturated Ca(OH)₂ solution.

FIG. 9A shows gravimetric swelling data for the 5 gel compositions in DI Water. FIG. 9B shows gravimetric swelling data for the 5 gel compositions in cementitious pore fluid at pH 12.

FIG. 10 shows secondary electron images of 2% MBAM hydrogels in 3-day cured cement paste. Deswelled gel voids in cement paste were observed.

FIG. 11 shows secondary electron images of 2% MBAM 5% TPM hydrogels in 3-day cured cement paste. Deswelled gel voids in cement paste were observed.

FIGS. 12A and 12B shows secondary electron images of two behaviors observed with 5% TPM gels dissolving. FIG. 12A shows 5% TPM gels dissolving leaving open voids. FIG. 12B shows 5% TPM gels dissolving leaving filled voids.

FIG. 13 shows secondary electron images of 20% TPM hydrogels in 3-day cured cement paste. No macrovoid formation was observed.

FIG. 14 shows secondary electron images of 2% MBAM 20% TPM hydrogels in 3-day cured cement paste. Reduction in macrovoid volume was observed.

FIGS. 15A to 15E show representative secondary electron images of microstructures showing the morphology of the varying gel compositions with varying amounts of TPM loading and with/without MBAM crosslinks in 3 day cured cement paste. FIG. 15A shows a representative 2% MBAM hydrogel. FIG. 15B shows a representative 2% MBAM 5% TPM hydrogel. FIG. 15C shows a representative 2% MBAM 20% TPM hydrogel. FIG. 15D shows a representative 5% TPM hydrogel. FIG. 15E shows a representative 20% TPM hydrogel.

FIG. 16A shows a secondary electron image of a representative 20% TPM gel in in 3-day cured cement paste. FIG. 16B shows a magnified section of FIG. 16A with a needlelike phase growing. FIG. 16C shows a further magnified section of FIG. 16A with a needlelike phase growing.

FIG. 17 shows a secondary electron image showing an even further magnified section of FIG. 16A with a needlelike C-S-H growing from 20% TPM gel in 3-day cured cement paste.

FIGS. 18A to 18E show CryoSEM images of the structure of the 5 gel compositions swelled in DI water for 24 hours. FIG. 18A shows a representative 2M hydrogel. FIG. 18B shows a representative 2M5T hydrogel. FIG. 18C shows a representative 2M20T hydrogel. FIG. 18D shows a representative 5T hydrogel. FIG. 18E shows a representative 20T hydrogel.

FIG. 19A shows a representative Cryogenic SEM image of a 2% MBAM hydrogel swelled in DI water. FIG. 19B shows a representative Cryogenic SEM image of a 2% MBAM 20% TPM swelled in DI water. FIG. 19C shows a representative Cryogenic SEM image of a 2% MBAM 20% TPM swelled in pore fluid overnight.

FIGS. 20A to 20F show representative CryoSEM micrographs comparing hydrogels swelled for 24 hours. FIG. 20A shows a representative Cryogenic SEM image of a 2M swelled in DI water for 24 hours. FIG. 20B shows a representative Cryogenic SEM image of a 2M5T swelled in DI water for 24 hours. FIG. 20C shows a representative Cryogenic SEM image of a 2M20T swelled in DI water for 24 hours. FIG. 20D shows a representative Cryogenic SEM image of a 2M swelled in basic pore fluid for 24 hours. FIG. 20E shows a representative Cryogenic SEM image of a 2M5T swelled in basic pore fluid for 24 hours. FIG. 20F shows a representative Cryogenic SEM image of a 2M20T swelled in basic pore fluid for 24 hours.

FIG. 21 shows a representative CryoSEM image of globular hydrate growth concentrated at the interface between 2M gel (left) and Portland cement paste (right) after 3 hours curing. The interface is marked with a dotted line.

FIGS. 22A to 22C show representative CryoSEM images showing gel-cement interfaces between gels and cement paste after 3 hours curing. Interface marked with a dashed line and features of interest noted. FIG. 22A shows a representative CryoSEM image at the interface between 2M gel (left) and Portland cement paste (right). FIG. 22B shows a representative CryoSEM image at the interface between 2M5T gel (left) and Portland cement paste (right). FIG. 22C shows a representative CryoSEM image at the interface between 2M20T gel (left) and Portland cement paste (right).

FIGS. 23A to 23C show representative CryoSEM images showing gel-cement interfaces between gels and cement paste after 18 hours curing. Interface marked with a dashed line and features of interest noted. FIG. 23A shows a representative CryoSEM image at the interface between 2M gel (left) and Portland cement paste (right). FIG. 23B shows a representative CryoSEM image at the interface between 2M5T gel (left) and Portland cement paste (right). FIG. 23C shows a representative CryoSEM image at the interface between 2M20T gel (left) and Portland cement paste (right).

FIGS. 24A to 24C show representative CryoSEM images showing gel-cement interfaces between gels and cement paste after 21 hours curing. Interface marked with a dashed line and features of interest noted. FIG. 24A shows a representative CryoSEM image at the interface between 2M gel (left) and Portland cement paste (right). FIG. 24B shows a representative CryoSEM image at the interface between 2M5T gel (left) and Portland cement paste (right). FIG. 24C shows a representative CryoSEM image at the interface between 2M20T gel (left) and Portland cement paste (right).

FIG. 25 shows a graph of slump values for the mortar mixes with composite SAPs, commercial SAPs, and no SAP with water/cement ratio required to maintain slump of the control mortar (No SAP).

FIG. 26 shows a graph of autogenous shrinkage data for the composite SAPS, a commercially available SAP, and a control with No SAP.

FIG. 27 shows a graph of compression strength data on mortar samples with composite SAPs, no SAP (control), and sample with a commercially available SAP.

FIG. 28 shows a graph of flexural strength data for mortar samples with composite SAPs, no SAP (control), and sample with a commercially available SAP.

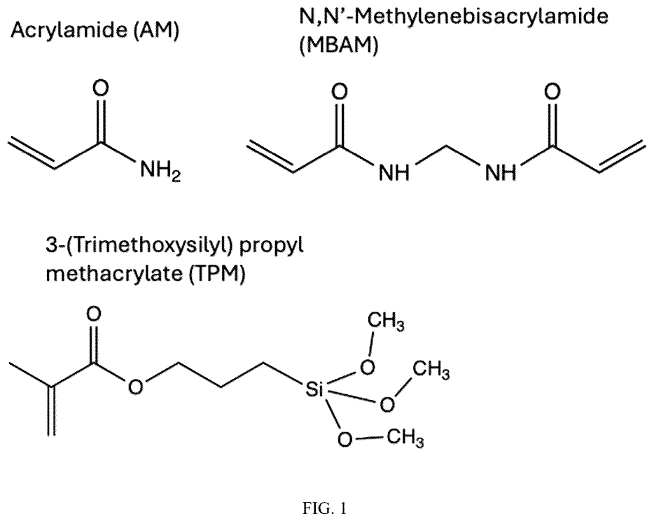

### DETAILED DESCRIPTION

An object of present disclosure is to provide organic-inorganic composite gels for use in a cementitious mixture. The organic-inorganic composite gels may be useful for studying the potential of a silica-functionalized hydrogel to nucleate and grow C-S-H within, and to observe the interactions between neat and silica-functionalized gels and cementitious mixtures.

Another object of the present disclosure is to provide a multifunctional powdered polymer-silicate admixture that produces stronger and longer-lasting cement. Silica additives (silica fume or nanosilica) and calcium-silicate-hydrates (C-S-H) seeding agents are widely popular in the cement industry to help create high-strength ‘glue’ within cement that binds together concrete aggregates. However, the silica-based particles can produce significant inhalation hazards when incorporated into cement.

Among the other objects and features of the present disclosure is to provide concrete with greater strength and service life by reducing concrete compaction and shrinkage during placement while encouraging and controlling the growth of strengthening phases (C-S-H seeding). Instead of traditional single-purpose silica-based particles, this innovative technology uses pH responsive organic silicate groups that are bound within a polymer particle. The resulting powdered admixture acts as a C-S-H seeding agent that can nucleate and grow concrete strengthening phases during early cement hydration. Moreover, at later time scales, the admixture acts as both an internal curing agent and air entraining agent. The admixture is produced as a dry powder that is easily incorporated into cast and printed cementitious systems. Before the present disclosure is further described, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

### Definitions

Unless defined otherwise, all technical and scientific terms used herein have the same meaning as is commonly understood by one of ordinary skill in the art to which this disclosure belongs. All patents, applications, published applications and other publications referred to herein are incorporated by reference in their entireties. If a definition set forth in this section is contrary to or otherwise inconsistent with a definition set forth in a patent, application, or other publication that is herein incorporated by reference, the definition set forth in this section prevails over the definition incorporated herein by reference.

As used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As used herein, the terms “including,” “containing,” and “comprising” are used in their open, non-limiting sense.

The term “about” as used herein means greater or lesser than the value or range of values stated by 10 percent, but is not intended to designate any value or range of values to only this broader definition. Each value or range of values preceded by the term “about” is also intended to encompass the embodiment of the stated absolute value or range of values.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. Whenever a yield is given as a percentage, such yield refers to a mass of the entity for which the yield is given with respect to the maximum amount of the same entity that could be obtained under the particular stoichiometric conditions. Concentrations that are given as percentages refer to mass ratios, unless indicated differently.

As used herein, the terms “alkyl” and “alkylene” include a chain of carbon atoms, which is optionally branched and contains from 1 to 20 carbon atoms. The term “alkyl” refers to a straight- or branched-chain monovalent hydrocarbon group. The term “alkylene” refers to a straight- or branched-chain divalent hydrocarbon group. In some embodiments, it can be advantageous to limit the number of atoms in an “alkyl” or “alkylene” to a specific range of atoms, such as C₁-C₂₀ alkyl or C₁-C₂₀ alkylene, C₁-C₁₂ alkyl or C₁-C₁₂ alkylene, or C₁-C₆ alkyl or C₁-C₆ alkylene. Examples of alkyl groups include methyl (Me), ethyl (Et), n-propyl, isopropyl, butyl, isobutyl, sec-butyl, tert-butyl (tBu), pentyl, isopentyl, tert-pentyl, hexyl, isohexyl, and groups that in light of the ordinary skill in the art and the teachings provided herein would be considered equivalent to any one of the foregoing examples. Examples of alkylene groups include methylene (—CH₂—), ethylene ((—CH₂—)₂), n-propylene ((—CH₂—)₃), iso-propylene ((—C(H)(CH₃)CH₂—)), n-butylene ((—CH₂—)₄), and the like. It will be appreciated that an alkyl or alkylene group can be unsubstituted or substituted as described herein. For example, it will be appreciated that any hydrogen atom on “alkyl” or “alkylene” can be replaced with a substituent as described herein.

An alkyl or alkylene group can be substituted with any of the substituents in the various embodiments described herein, including one or more of such substituents. It will be understood that “alkyl” or “alkylene” may be combined with other groups, such as those provided above, to form a functionalized alkyl. Other non-limiting examples of an “alkylene” group, as described herein, with “silyl” group include “alkylene-silyl” or “alkylsilyl”.

As used herein, the term “alkenyl” includes a chain of carbon atoms, which is optionally branched, and contains from 2 to 20 carbon atoms, and also includes at least one carbon-carbon double bond (i.e., C═C). It will be understood that in certain embodiments, alkenyl may be advantageously of limited length, including C₂-C₁₂, C₂-C₉, C₂-C₈, C₂-C₇, C₂-C₆, and C₂-C₄. Illustratively, such particularly limited length alkenyl groups, including C₂-C₈, C₂-C₇, C₂-C₆, and C₂-C₄ may be referred to as lower alkenyl. Illustrative alkenyl groups include, but are not limited to, ethenyl, 1-propenyl, 2-propenyl, 1-, 2-, or 3-butenyl, and the like. Alkenyl may be unsubstituted, or substituted as described for alkyl or as described in the various embodiments provided herein. For example, it will be appreciated that any hydrogen atom on “alkenyl” can be replaced with a substituent as described herein.

As used herein, the term “alkynyl” includes a chain of carbon atoms, which is optionally branched, and contains from 2 to 20 carbon atoms, and also includes at least one carbon-carbon triple bond (i.e., C═C). It will be understood that in certain embodiments, alkynyl may each be advantageously of limited length, including C₂-C₁₂, C₂-C₉, C₂-C₈, C₂-C₇, C₂-C₆, and C₂-C₄. Illustratively, such particularly limited length alkynyl groups, including C₂-C₈, C₂-C₇, C₂-C₆, and C₂-C₄ may be referred to as lower alkynyl. Illustrative alkynyl groups include, but are not limited to, ethynyl, 1-propynyl, 2-propynyl, 1-, 2-, or 3-butynyl, and the like. Alkynyl may be unsubstituted, or substituted as described for alkyl or as described in the various embodiments provided herein. For example, it will be appreciated that any hydrogen atom on “alkynyl” can be replaced with a substituent as described herein.

As used herein, the term “cycloalkyl” refers to a 3 to 15 member all-carbon monocyclic ring, including an all-carbon 5-member/6-member or 6-member/6-member fused bicyclic ring, or a multicyclic fused ring (a “fused” ring system means that each ring in the system shares an adjacent pair of carbon atoms with each other ring in the system) group, or a carbocyclic ring that is fused to another group such as a heterocyclic, such as ring 5- or 6-membered cycloalkyl fused to a 5- to 7-membered heterocyclic ring, where one or more of the rings may contain one or more double bonds but the cycloalkyl does not contain a completely conjugated pi-electron system. It will be understood that in certain embodiments, cycloalkyl may be advantageously of limited size such as C₃-C₁₃, C₃-C₉, C₃-C₆ and C₄-C₆. Cycloalkyl may be unsubstituted, or substituted as described for alkyl or as described in the various embodiments provided herein. For example, it will be appreciated that any hydrogen atom on “cycloalkyl” can be replaced with a substituent as described herein. Illustrative cycloalkyl groups include, but are not limited to, cyclopropyl, cyclobutyl, cyclopentyl, cyclopentenyl, cyclopentadienyl, cyclohexyl, cyclohexenyl, cycloheptyl, adamantyl, norbornyl, norbornenyl, and the like. Illustrative examples of cycloalkyl groups shown in graphical representations include the following entities, in the form of properly bonded moieties:

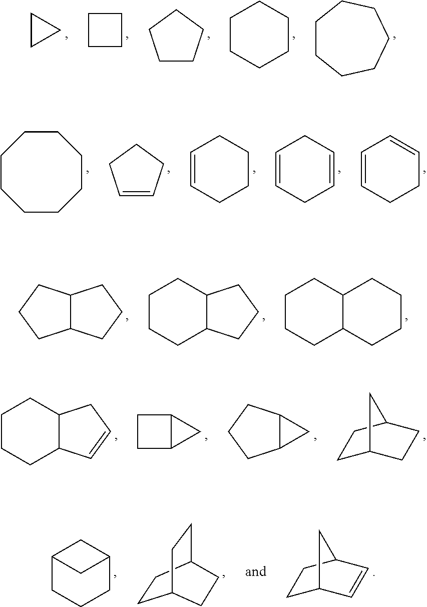

As used herein, “halo” or “halogen” refers to fluorine, chlorine, bromine, or iodine.

As used herein, “cyano” refers to a —CN group.

As used herein, “hydroxy” or “hydroxyl” refers to an —OH group.

As used herein, “oxide” refers to an oxygen atom attached to another atom, represented by the formula —O⁻.

The terms “acryloyl” and “acrylic,” as used herein, refer to a group

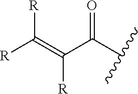

wherein each R independently represent a hydrogen or hydrocarbyl group, or two R are taken together with the atom(s) to which they are attached form a cyclic compound having from 4 to 8 atoms in the ring structure. A compound containing an acryloyl group can be referred to as an “acrylic compound,” such as an acrylic monomer. Representative examples of acrylic compounds and/or acrylic monomers include, but are not limited to, methyl vinyl ketone, acrolein, methyl acrylate, ethyl acrylate, acrylamide, methacrylamide, acrylic acid, methacrylic acid, maleic acid, fumaric acid, acryloyl chloride, and the like. The term and “bisacrylic,” as used herein, refers to a compound, such as a monomer, including two acrylic groups. A representative example of a bisacrylic compound and/or bisacrylic monomer is methylenebisacrylamide (MBAM).

The terms “amide” and “amido,” as used herein, refer to a group

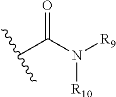

wherein R⁹ and R¹⁰ each independently represent a hydrogen or hydrocarbyl group, or R⁹ and R¹⁰ taken together with the N atom to which they are attached form a heterocycle having from 4 to 8 atoms in the ring structure.

The terms “amine” and “amino” are art-recognized and refer to both unsubstituted and substituted amines and salts thereof, e.g., a moiety that can be represented by

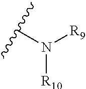

wherein R⁹ and R¹⁰, each independently represent a hydrogen or a hydrocarbyl group, or R⁹ and R¹⁰ taken together with the N atom to which they are attached complete a heterocycle having from 4 to 8 atoms in the ring structure. Amines include, but are not limited to, ammonia, methylamine, dimethyl amine, trimethylamine, ethylamine, diethylamine, triethylamine, pyrrolidine, pyrrole, imidazole, pyridine, pyrimidine, pyridazine, pyrazine, and the like.

The term “hydrocarbyl,” as used herein, refers to a group that is bonded through a carbon atom that does not have a ═O or ═S substituent, and typically has at least one carbon-hydrogen bond and a primarily carbon backbone, but may optionally include heteroatoms. Thus, groups like methyl, ethoxyethyl, 2-pyridyl, and even trifluoromethyl are considered to be hydrocarbyl for the purposes of this application, but substituents such as acetyl (which has a ═O substituent on the linking carbon) and ethoxy (which is linked through oxygen, not carbon) are not. Hydrocarbyl groups include, but are not limited to aryl, hetaryl, carbocycle, heterocycle, alkyl, alkenyl, alkynyl, and combinations thereof.

The term “alkoxy” refers to an alkyl group having an oxygen attached thereto. Representative alkoxy groups include methoxy, ethoxy, propoxy, tert-butoxy and the like.

The term “oxo” represents a carbonyl oxygen.

The term “carbonyl” is art-recognized and refers to a group —C(O)— where a double bond exists between the carbon and oxygen.

As used herein, “bond” refers to a covalent bond.

The term “silyl” refers to a group —SiR₃, wherein each R independently represents hydrogen, halogen, alkoxy, or hydrocarbyl. It will be understood that “silyl” may be combined with other groups, such as those provided above, to form a functionalized silyl. Non-limiting examples of a “silyl” group, as described herein, with an alkoxy group or a halo group include “alkoxysilyl” or “halosilyl,” respectively.

The term “silane” refers to a compound comprising a silicon atom. For example, a silane refers to a compound of the formula SiR₄, wherein each R independently represents hydrogen, halogen, alkoxy, or hydrocarbyl. Examples of silanes include hydrosilanes (i.e., silanes containing one or more Si—H bond), halosilanes (i.e., silanes containing one or more Si-halogen bond), alkoxysilanes (i.e., silanes containing one or more Si—O-alkyl bond), and organosilanes (i.e., silanes containing one or more Si—C bond). It will be understood that silanes can be a combination of more than one functional group. For example, the term “organoalkoxysilane” refers to a silane containing at least one Si—C bond and at least one S—O-alkyl bond. In some embodiments, an organosilane, or silane coupling agent, has a polymerizable organic functional group that can form a portion of a polymer and act as a crosslinking agent. Silanes (e.g., alkoxysilanes) can be useful for making silica-based structures and hybrid nanocomposite materials.

The term “siloxane” refers to a group of two silicon atoms bound to an oxygen atom: Si—O—Si.

The term “organosiloxane” refers to a siloxane containing at least one carbon-silicon bond.

The term “ester,” as used herein, refers to a group —C(O)OR⁹ wherein R⁹ represents a hydrocarbyl group.

The term “ether,” as used herein, refers to a hydrocarbyl group linked through an oxygen to another hydrocarbyl group. Accordingly, an ether substituent of a hydrocarbyl group may be hydrocarbyl-O—. Ethers may be either symmetrical or unsymmetrical. Ethers include “alkoxyalkyl” groups, which may be represented by the general formula alkyl-O-alkyl.

The term “C_{x-y}” or “Cₓ-C_{y},” when used in conjunction with a chemical moiety, such as, acyl, acyloxy, alkyl, alkenyl, alkynyl, or alkoxy is meant to include groups that contain from x to y carbons in the chain. Co alkyl indicates a hydrogen where the group is in a terminal position, a bond if internal. A C₁₋₆ alkyl group, for example, contains from one to six carbon atoms in the chain.

As used herein, the suffix “-yl” refers to substituent groups where a radical that is bonded to a radical of an atom on molecule to form a covalent bond. For example, —CH₃ represents a methyl radical that is bonded to a radical atom so that a covalent bond is formed to form a methyl group bonded to the remaining portion of the molecule.

As used herein, the suffix “-ylene” refers to a diradical group that is bonded to two substituents to form two covalent bonds. For example, —CH₂— represents a methylene diradical that is bonded to a radical atom on each side of the carbon so that two covalent bonds are formed to the remaining portions of the molecule. It should be understood that functional groups and substituents described herein with the “-yl” suffix can be readily envisaged to the corresponding “-ylene” suffix to bond to two separate substituents, for example alkyl and alkenyl (forming one bond) would become alkylene and alkenylene, respectively, when forming two bonds.

The term “substituted” means that the specified group or moiety bears one or more substituents. The term “unsubstituted” means that the specified group bears no substituents. Where the term “substituted” is used to describe a structural system, the substitution is meant to occur at any valency-allowed position on the system. In some embodiments, “substituted” means that the specified group or moiety bears one, two, or three substituents. In other embodiments, “substituted” means that the specified group or moiety bears one or two substituents. In still other embodiments, “substituted” means the specified group or moiety bears one substituent. Substituents can include any substituents described herein, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or hetaryl moiety. It will be understood by those skilled in the art that the moieties substituted on the hydrocarbon chain can themselves be substituted, if appropriate.

As used herein, “optional” or “optionally” means that the subsequently described event or circumstance may but need not occur, and that the description includes instances where the event or circumstance occurs and instances in which it does not. For example, “wherein each hydrogen atom in alkyl is independently optionally substituted by OH, halogen, or alkoxy” means that a OH, halogen, or alkyloxy may be, but need not be, present on alkyl by replacement of a hydrogen atom for each C₁-C₆ alkyl group, and the description includes situations where the alkyl is substituted with an OH, halogen, or alkyloxy group and situations where the alkyl is not substituted with the OH, halogen, or alkyloxy group.

As used herein, the term “dissolvable,” when referring to a siloxane, can indicate the capability of the siloxane to degrade (e.g., hydrolyze or oxidize) in the presence of a base or under oxidation conditions. For example, a dissolvable siloxane can refer to a siloxane that produces silanols and water in the presence of a base, such as calcium hydroxide. For example, hexamethyldisiloxane (((CH₃)₃Si)₂O) will dissolve/hydrolyze in the presence of base, such as NaOH, to (CH₃)₃SiONa and H₂O.

As used herein, “polymer” refers to a substance or material composed of many repeating subunits, or “monomers.” As used herein, “copolymer” means a polymer composed of more than one monomer. Representative examples of polymers include, but are not limited to, polyvinylacetate, polyacrylamide, polymethacrylate, polyethylene, polyvinyl alcohol, polyvinylamine. Representative examples of copolymers include, but are not limited to, any combination of two or more monomers or polymers listed herein.

As used herein, “monomer” refers to a single compound that can react, or polymerize, with other monomers to form a polymer. It would be understood that a monomer can refer to a compound that includes a polymerizable group, such as a double bond (e.g., an acrylic group), or a compound that includes a polymerizable group that can form a portion of a polymer or copolymer, such as being incorporated into a polymer or copolymer by polymerization. For example, acrylamide (an acrylic monomer) can be represented by either of the following structures:

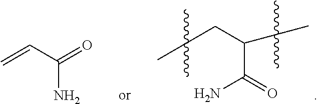

A monomer with two polymerizable groups that can each form a portion of a polymer or copolymer, such as being incorporated into a polymer or copolymer by polymerization, for example, methylenebisacrylamide (MBAM) can be represented by any one of the following structures:

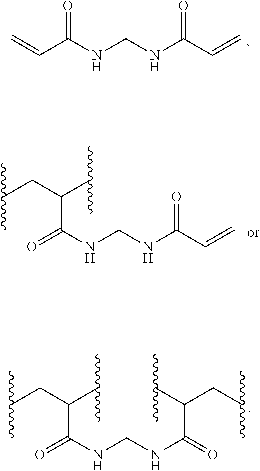

As used herein, “network polymer” refers to a three-dimensional structure made up of macromolecules (e.g., polymers) that are chemically or physically linked together. A network polymer, for example, includes monomers that interact to form covalent bonds (e.g., crosslink) between linear polymer chains.

As used herein, “cementitious material” refers to cement, slag, and other supplementary cementitious materials (SCMs), such as fly ash, silica fume, and nanosilica.

As used herein, “biodegradable” refers to a compound or composition that is capable of being broken down, especially into innocuous products. For example, a biodegradable wrapping material can include paper from trees, crops like hemp, or agricultural byproducts like wheat straw and sugarcane fiber.

As used herein, the term “dissolvable,” when referring to a biodegradable material (e.g., a wrapping material), can indicate the capability of the material to degrade into innocuous products.

As used herein, the term “curing” refers to the action taken to maintain moisture and temperature conditions in a placed cementitious mixture to allow cement hydration and, if applicable, pozzolanic reactions to occur so that the potential properties of the mixture may develop. For example, curing can refer to a chemical reaction (e.g., a pozzolanic reaction) between water and a cementitious material, such as cement, to provide a water-cured composition that can be referred to as a “hydraulic” composition. A “cured” composition refers to a cementitious mixture that has begun or undergone curing, and has begun or undergone setting and hardening.

As used herein and in connection with chemical structures depicting the various embodiments described herein, “*”, “**”, and “ [symbol] ”, each represent a point of covalent attachment of the chemical group or chemical structure in which the identifier is shown to an adjacent chemical group or chemical structure. For example, in a hypothetical chemical structure A-B, where A and B are joined by a covalent bond, in some embodiments, the portion of A-B defined by the group or chemical structure A can be represented by “A-*”, “A-**”, or,

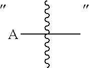

where each of “-*”, “-**”, and

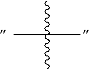

represents a bond to A and the point of covalent bond attachment to B. Alternatively, in some embodiments, the portion of A-B defined by the group or chemical structure B can be represented by “-B”, “**-B”, or

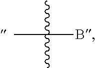

where each of “_*”, “-**”, and

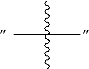

represents a bond to B and the point of covalent bond attachment to A.

As used herein, “independently” means that the subsequently described event or circumstance is to be read on its own relative to other similar events or circumstances. For example, in a circumstance where several equivalent hydrogen groups are optionally substituted by another group described in the circumstance, the use of “independently optionally” means that each instance of a hydrogen atom on the group may be substituted by another group, where the groups replacing each of the hydrogen atoms may be the same or different. Or for example, where multiple groups exist all of which can be selected from a set of possibilities, the use of “independently” means that each of the groups can be selected from the set of possibilities separate from any other group, and the groups selected in the circumstance may be the same or different.

As used herein, “admixture” refers to a material in the form of powder or fluids that are added to concrete to provide certain characteristics not obtainable with plain concrete mixes. An admixture, for example, can refer to a material added to a concrete mix as it is being prepared.

As used herein, “mortar” refers to a mixture of cement, water, and (quartz) sand that can be used to bind materials, such as building or construction materials. Mortar can also include additives, such as silica fume.

As used herein, “slump” refers to a measure of flowability of the mixture. The “% slump” in some cementitious compositions, such as those for 3D printing, may be required to be maintained with different additives.

As used herein, “superabsorbent polymer (SAP)” refers to a water-absorbing hydrophilic homopolymer or copolymer that can absorb and retain extremely large amounts of a liquid relative to its own mass. An example of a commercially available SAP is FLOSET™ 27-CS available from SNF Floerger used for water treatment applications. As used herein, “composite SAP” refers to an inorganic-organic composite according to the present disclosure.

### REPRESENTATIVE EMBODIMENTS

In some embodiments, the disclosure provides an organic-inorganic composite comprising: an acrylic polymer; a siloxane; and a crosslinker. In some embodiments, the crosslinker interconnects the siloxane and the acrylic polymer to form the composite. In some embodiments, the crosslinker comprises an acrylic group. In some embodiments, the crosslinker comprises an acrylic group that forms a portion of the acrylic polymer. In some embodiments, the crosslinker comprises silicon atom. In some embodiments, the crosslinker comprises a silicon atom that forms a portion of the siloxane.

In some embodiments, the disclosure provides an organic-inorganic composite comprising: an acrylic polymer; and a crosslinker comprising a siloxane. In some embodiments, the crosslinker comprising a siloxane extends between and interconnects two or more (e.g., 2 to 8) portions of the acrylic polymer. In some embodiments, the crosslinker comprises a first acrylic group that forms a first portion of the acrylic polymer. In some embodiments, the crosslinker comprises a second acrylic group that forms a second portion of the acrylic polymer. In some embodiments, the crosslinker comprises a first acrylic group that forms a first portion of the acrylic polymer, a second acrylic group that forms a second portion of the acrylic polymer, and a siloxane extending between and interconnecting the first portion of the acrylic polymer and the second portion of the acrylic polymer.

In some embodiments, the siloxane is an organosilane (e.g., an organosiloxane). In some embodiments, the siloxane is dissolvable.

In some embodiments, the crosslinker comprises a carbon-silicon bond. In some embodiments, the carbon-silicon bond comprises the silicon atom that forms a portion of the siloxane. In some embodiments, the crosslinker is of the formula:

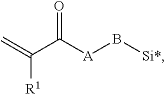

wherein A is O, NH, or a bond; B is alkylene, alkenylene, alkynylene, cycloalkylene, cycloalkenylene, arylene, or heteroarylene; and R¹ is H, alkyl, alkenyl, alkynyl, cycloalkyl, or cycloalkenyl; and wherein “*” represents a portion of the siloxane. In some embodiments, B—Si is a carbon-silicon bond. In some embodiments, A is O or NH. In some embodiments, B is C₁-C₆ alkylene (e.g., ethylene). In some embodiments, R¹ is H or C₁-C₆ alkyl (e.g., methyl). In certain preferred embodiments, the crosslinker is of the structure:

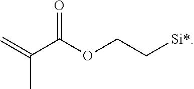

In some embodiments, the crosslinker comprises a portion of the formula Ia:

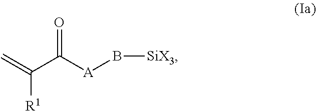

wherein:
each A is independently O, NH, or a bond;
each B is independently alkylene or cycloalkylene;
R¹ is H, alkyl, or cycloalkyl; and
each X is independently OH, halogen, alkoxy, or

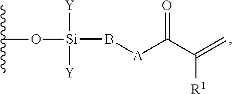

wherein each Y is independently OH, halogen, or alkoxy.

In some embodiments, the crosslinker comprises a portion of the formula Ib:

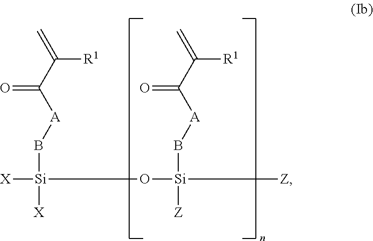

wherein:
each A is independently O, NH, or a bond;
each B is independently alkylene or cycloalkylene;
each R¹ is independently H, alkyl, or cycloalkyl;
each X is independently OH, halogen, or alkoxy, or

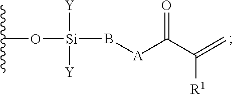

each Y is independently OH, halogen, or alkoxy;
Z is OH, halogen, alkoxy, or a Z and an X or a Y come together with an oxygen atom and the silicon atom to which they are attached to form a Si—O—Si; and
n is an integer (e.g., an integer of 1 to 50).

In some embodiments, the crosslinker comprises a portion of the formula Ic:

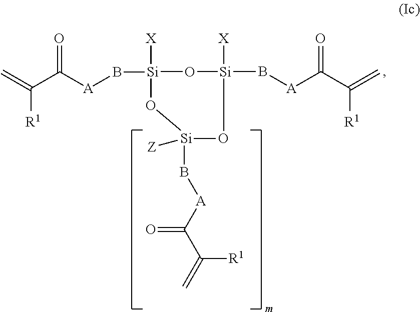

wherein:
each A is independently O, NH, or a bond;
each B is independently alkylene or cycloalkylene;
each R¹ is independently H, alkyl, or cycloalkyl;
each X is independently OH, halogen, or alkoxy, or

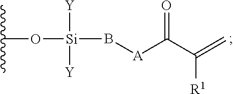

each Y is independently OH, halogen, or alkoxy;
Z is OH, halogen, alkoxy, or a Z and an X or a Y come together with an oxygen atom and the silicon atom to which they are attached to form a Si—O—Si; and
m is an integer (e.g., an integer of 1 to 50).

In some embodiments, each A is independently O, NH, or a bond. In certain preferred embodiments, each A is O.

In some embodiments, each B is independently alkylene (e.g., C₁-C₁₂ alkylene) or cycloalkylene (e.g., C₃-C₁₂ cycloalkylene). In some embodiments, each B is independently alkylene (e.g., C₁-C₁₂ alkylene), such as methylene, ethylene, propylene, or butylene, wherein each hydrogen atom in alkylene is independently optionally substituted by OH, halogen, or alkoxy. In some embodiments, each B is independently unsubstituted alkylene (e.g., C₁-C₁₂ alkylene), such as methylene, ethylene, propylene, or butylene. In certain preferred embodiments, each B is propylene.

In some embodiments, each R¹ is independently H, alkyl, or cycloalkyl. In some embodiments, each R¹ is independently H, alkyl (e.g., C₁-C₁₂ alkyl), or cycloalkyl (e.g., C₃-C₁₂ cycloalkyl). In some embodiments, each R¹ is independently H or alkyl (e.g., C₁-C₁₂ alkyl), such as methyl, ethyl, propyl, or butyl, wherein each hydrogen atom in alkyl is independently optionally substituted by OH, halogen, or alkoxy. In certain preferred embodiments, each R¹ is methyl.

In some embodiments, each X is independently OH, halogen, alkoxy (e.g., C₁-C₆ alkoxy), or

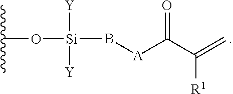

In some embodiments, each X is independently OH, or alkoxy (e.g., C₁-C₆ alkoxy), or

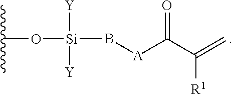

In some embodiments, each Y is independently OH, halogen, or alkoxy (e.g., C₁-C₆ alkoxy). In some embodiments, each Y is independently OH or alkoxy.

In some embodiments, Z is OH, halogen, alkoxy, or a Z and an X or a Y come together with an oxygen atom and the silicon atom to which they are attached to form a Si—O—Si. In some embodiments, Z is OH, alkoxy, or a Z and an X or a Y come together with an oxygen atom and the silicon atom to which they are attached to form a Si—O—Si.

In some embodiments, n is an integer (e.g., an integer of 1 to 50). In some embodiments, n is an integer of 1 to 30, 1 to 24, 1 to 12, or 1 to 8.

In some embodiments, m is an integer (e.g., an integer of 1 to 50). In some embodiments, m is an integer of 1 to 30, 1 to 24, 1 to 12, or 1 to 8.

In some embodiments, the composite (e.g., the acrylic polymer) is a network polymer.

In some embodiments, the composite (e.g., the acrylic polymer) comprises an acrylic monomer comprising an acrylic group (e.g., a polymerizable functional group) that forms a portion of the acrylic polymer. In some embodiments, the acrylic monomer is selected from the group consisting of acrylamide, methacrylamide, acrylic acid, methacrylic acid, alkyl acrylate, alkyl methacrylate, and any combination thereof. In certain preferred embodiments, the acrylic monomer is acrylamide.

In some embodiments, the composite (e.g., the acrylic polymer) comprises about 50 wt % to about 99.9 wt % of the acrylic monomer. In some embodiments, the composite comprises about 70 wt % to about 99 wt % of the acrylic monomer.

In some embodiments, the composite (e.g., the acrylic polymer) comprises a bifunctional monomer (e.g., a bisacrylic monomer) comprising two functional groups (e.g., polymerizable functional groups) that each form a portion of the acrylic polymer. In some embodiments, the bifunctional monomer is selected from the group consisting of divinyl sulfone (DVS), epichlorohydrin, glutaraldehyde, glyoxal, and genipin.

In some embodiments, the composite (e.g., the acrylic polymer) comprises a bisacrylic monomer comprising two acrylic groups (e.g., polymerizable functional groups) that each form a portion of the acrylic polymer. In some embodiments, the bisacrylic monomer is selected from the group consisting of methylenebisacrylamide (MBAM), N,N′-ethylenebisacrylamide (EBAM), N,N′-bisacryloyl cystamine (BAC), N,N′-bis(acryloyl) ethylene diamine (BAED), polyethylene glycol diacrylate (PEGDA), 1,4-butanediol diacrylate (BDDA), and any combination thereof. In certain preferred embodiments, the bisacrylic monomer is methylenebisacrylamide (MBAM).

In some embodiments, the composite comprises about 0.1 wt % to about 10 wt % of the bifunctional monomer (e.g., bisacrylic monomer). In some embodiments, the composite comprises about 0.5 wt % to about 5 wt % of the bifunctional monomer.

In some embodiments, the composite comprises a crosslinking monomer comprising an acrylic group (e.g., a polymerizable functional group) that forms a portion of the acrylic polymer and a silyl group. In some embodiments, the crosslinking monomer is an organosilane (e.g., an organoalkoxysilane or organohalosilane). In some embodiments, the silyl group is a hydroxysilyl, an alkoxysilyl, or a halosilyl group.

In some embodiments, the crosslinking monomer comprises a hydroxysilyl, an alkoxysilyl, or a halosilyl group. In some embodiments, the crosslinking monomer comprises a silylalkyl acrylate, a silylalkyl methacrylate, or a combination thereof. In some embodiments, the crosslinking monomer comprises a trialkoxysilyl alkyl acrylate or a trialkoxysilyl alkyl methacrylate. In certain preferred embodiments, the crosslinking monomer is trimethoxysilyl propyl methacrylate (TPM).

In some embodiments, the composite comprises about 0.1% to about 50% by weight of the crosslinking monomer, the crosslinker, or combination thereof. In some embodiments, the composite comprises about 1% to about 25% by weight of the crosslinking monomer, the crosslinker, or combination thereof.

In some embodiments, the composite is a solid (e.g., a powder). In some embodiments, the composite is an angular powder or a spherical powder. In some embodiments, the composite (e.g., a powder, such as an angular powder) comprises particles of about 100 microns to about 500 microns in diameter, or about 200 microns to about 500 microns in diameter. Properties of the composite (e.g., properties of a solid, powder, or particle), such as size (e.g., diameter) and shape, can be determined by optical microscopy and image analysis.

In some embodiments, the composite comprises water. A composite comprising water, for example, may have a hydrogel structure. In some embodiments, the composite comprising water has a greater swelling ratio in water at a higher pH (e.g., pH greater than about 8 or greater than about 10). At a higher pH, for example, siloxane bonds may dissolve and/or polyacrylamide may hydrolyze, thereby increasing the swelling ratio.

In some embodiments, the composite has a swelling ratio (e.g., ratio of weight of swollen hydrogel to the weight of dry hydrogel, sometimes called “Q”) of about 2 to about 10 in water at a pH of about 6 to about 8. In some embodiments, the composite has a swelling ratio of about 5 to about 15 in water at a pH of about 11 to about 13.

In some embodiments, the composite comprising water has an average pore size of about 1 to about 100 nm in water at a pH of about 6 to about 8. In some embodiments, the composite comprising water has an average pore size of about 100 to about 1000 nm in water at a pH of about 11 to about 13. In some embodiments, the disclosure provides a cementitious composition comprising: the organic-inorganic composite as described herein, and a cementitious material. The cementitious material can be cement, slag, supplementary cementitious material, and any combination thereof. In certain preferred embodiments, the cementitious material is cement. In some embodiments, the cementitious material comprises slag at about a 30% replacement by weight of cement.

In some embodiments, the cementitious composition comprises water. In some embodiments, the water is free from sewage, oil, acid, strong alkalis, vegetable matter, clay, and loam. In some embodiments, the cementitious composition has a pH of about 10 to about 14 (e.g., about 11 to about 13).

In some embodiments, the composite comprises about 0.01 wt % to about 1.0 wt % by weight of cementitious material. In some embodiments, the composite comprises about 0.1 wt % to about 0.5 wt % (e.g., about 0.15 wt %) by weight of cementitious material. In some embodiments, the cementitious composition comprises a water/cementitious material (e.g., water/cement) ratio of about 0.1 to about 1.0. In some embodiments, the cementitious composition comprises a water/cementitious material ratio of about 0.3 to about 0.6.

In some embodiments, the cementitious composition comprises about 0.1 pound to about 5 pounds composite per cubic yard of cementitious composition. In some embodiments, the cementitious composition comprises about 0.5 pound to about 2 pounds composite per cubic yard of cementitious composition. In some embodiments, the cementitious composition comprises about 1 pound composite per cubic yard of cementitious composition.

In some embodiments, the cementitious composition, including aggregate, comprises about 300 pounds to about 1000 pounds cementitious material per cubic yard of the composition. In some embodiments, the cementitious composition comprises about 500 pounds to about 700 pounds cementitious material per cubic yard of composition.

In some embodiments, the cementitious composition comprises an aggregate selected from the group consisting of sand, gravel, stone (e.g., limestone), and any combination thereof. In some embodiments, the aggregate is fine aggregate, coarse aggregate, or a combination thereof.

In some embodiments, the cementitious composition is a cured cementitious composition (e.g., a cured concrete).

In some embodiments, the cured cementitious composition has an average concrete compressive strength at 7 days or 28 days of greater than about 4000 pounds per square inch (e.g., about 4000 to about 7500 pounds per square inch) for Class C concrete. In some embodiments, the cured cementitious composition has an average concrete compressive strength at 7 days or 28 days of greater than about 3000 pounds per square inch (e.g., about 3000 to about 6000 pounds per square inch) for Class F concrete. In some embodiments, the cured cementitious composition has an average concrete compressive strength at 7 days or 28 days of greater than about 4500 pounds per square inch (e.g., about 4500 to about 8000 pounds per square inch) for Class S concrete.

In some embodiments, the cured cementitious composition has an average compressive strength at 7 days or 28 days of greater than about 70 MPa (e.g., about 70 MPa to about 150 MPa), greater than about 75 MPa, greater than about 80 MPa, or greater than about 85 MPa. In some embodiments, the cured cementitious composition has a water/cementitious material (e.g., water/cement) ratio of about 0.1 to about 1.0 (e.g., about 0.3 to about 0.6, about 0.3 to about 0.5, or about 0.3 to about 0.4) and an average compressive strength at 7 days or 28 days of greater than about 70 MPa (e.g., about 70 MPa to about 150 MPa), greater than about 75 MPa, greater than about 80 MPa, or greater than about 85 MPa.

In some embodiments, the cured cementitious composition has a flexural strength at 7 days or 28 days of greater than about 3 MPa (e.g., about 3 MPa to about 15 MPa), greater than about 5 MPa, greater than about 6 MPa, greater than about 7 MPa, greater than about 8 MPa, or greater than about 9 MPa. In some embodiments, the cured cementitious composition has a water/cementitious material (e.g., water/cement) ratio of about 0.1 to about 1.0 (e.g., about 0.3 to about 0.6, about 0.3 to about 0.5, or about 0.3 to about 0.4) and a flexural strength at 7 days or 28 days of greater than about 3 MPa (e.g., about 3 MPa to about 15 MPa), greater than about 5 MPa, greater than about 6 MPa, greater than about 7 MPa, greater than about 8 MPa, or greater than about 9 MPa.

In some embodiments, the cementitious composition comprises a water/cementitious material ratio that provides an equivalent concrete slump as a composition without the composite of the present disclosure. In some embodiments, the cementitious composition comprises a water/cementitious material ratio greater than the water/cementitious material of a composition without the composite of the present disclosure and provides an equivalent concrete slump. In some embodiments, the cementitious composition comprises a water/cementitious material ratio that provides an equivalent concrete slump as a composition with a comparative SAP. In some embodiments, the cementitious composition comprises a water/cementitious material ratio less than the water/cementitious material of a composition with a comparative SAP and provides an equivalent concrete slump.

In some embodiments, the cured cementitious composition has a concrete slump of less than about 10 inches, less than about 8 inches, less than about 6 inches, or less than about 5 inches. In some embodiments, the cured cementitious composition has a concrete slump of about 4 inches to about 10 inches, about 4 inches to about 8 inches, about 4 inches to about 6 inches, or about 4 inches to about 5 inches.

In some embodiments, the cured cementitious composition has a water/cementitious material (e.g., water/cement) ratio of about 0.1 to about 1.0 (e.g., about 0.3 to about 0.6, about 0.3 to about 0.5, or about 0.3 to about 0.4) and a concrete slump of less than about 10 inches, less than about 8 inches, less than about 6 inches, or less than about 5 inches. In some embodiments, the cured cementitious composition has a water/cementitious material (e.g., water/cement) ratio of about 0.1 to about 1.0 (e.g., about 0.3 to about 0.6, about 0.3 to about 0.5, or about 0.3 to about 0.4) and a concrete slump of about 4 inches to about 10 inches, about 4 inches to about 8 inches, about 4 inches to about 6 inches, or about 4 inches to about 5 inches.

In some embodiments, the cured cementitious composition has an autogenous shrinkage at 28 days of greater than about 0.05 mm/m, greater than about 0.1 mm/m, or greater than about 0.15 mm/m.

In some embodiments, the cured cementitious composition has a water/cementitious material (e.g., water/cement) ratio of about 0.1 to about 1.0 (e.g., about 0.3 to about 0.6, about 0.3 to about 0.5, or about 0.3 to about 0.4) and an autogenous shrinkage at 28 days of greater than about 0.05 mm/m, greater than about 0.1 mm/m, or greater than about 0.15 mm/m.

In some embodiments, the disclosure provides a package comprising the organic-inorganic composite as described herein. In some embodiments, the disclosure provides a package comprising the cementitious composition as described herein. In some embodiments, the package comprises a wrapping material configured to hold the composite or cementitious composition therein. In some embodiments, the wrapping material is configured to form a pouch, thereby holding the composite or cementitious composition therein. In some embodiments, the wrapping material is biodegradable. In some embodiments, the wrapping material dissolves when the package is added to a batch of water and cementitious material and/or aggregate for example during a mixing step, thereby releasing the composite into the composition.

In some embodiments, the package comprises a cementitious material selected from the group consisting of cement, slag, supplementary cementitious material, and any combination thereof. In certain preferred embodiments, the cementitious material is cement. In some embodiments, the cementitious material comprises cement and slag. In some embodiments, the cementitious material comprises slag at about a 30% replacement by weight of cement.

In some embodiments, the package comprises about 0.01 wt % to about 1.0 wt % composite by weight of cementitious material. In some embodiments, the cementitious composition comprises about 0.1 wt % to about 0.5 wt % composite by weight of cementitious material.

In some embodiments, the package comprises an aggregate selected from the group consisting of sand, gravel, stone, and any combination thereof.

In some embodiments, the disclosure provides a method of preparing an organic-inorganic composite as described herein comprising: contacting a monomer mixture with an initiator. In some embodiments, the method comprises contacting a monomer mixture with an initiator, thereby forming the composite as described herein.

In some embodiments, the monomer mixture comprises a crosslinking monomer and an acrylic monomer.

In some embodiments, the initiator is a polymerization initiator. In some embodiments the initiator is selected from sodium metabisulphite (Na₂S₂O₅), sodium persulfate (Na₂S₂O₈), or a combination thereof.

In some embodiments, the step of contacting is performed in the presence of a solvent. In some embodiments, the solvent is water. In some embodiments, the step of contacting is performed at a temperature of about 20° C. to about 70° C. (e.g., about 25° C. or room temperature). In some embodiments, the step of contacting is performed for about 10 minutes to about 36 hours (e.g., about 24 hours).

In some embodiments, the monomer mixture comprises about 0.1 wt % to about 50 wt % of the crosslinking monomer. In some embodiments, the monomer mixture comprises about 1 wt % to about 25 wt % of the crosslinking monomer.

In some embodiments, the crosslinking monomer comprises an acrylic group (e.g., a polymerizable functional group) and a silyl group. In some embodiments, the crosslinking monomer is an organosilane (e.g., an organoalkoxysilane or organohalosilane). In some embodiments, the crosslinking monomer comprises a hydroxysilyl, an alkoxysilyl, or a halosilyl group. In some embodiments, the crosslinking monomer comprises a silylalkyl acrylate, a silylalkyl methacrylate, or a combination thereof. In some embodiments, the crosslinking monomer comprises a trialkoxysilyl alkyl acrylate or a trialkoxysilyl alkyl methacrylate. In certain preferred embodiments, the crosslinking monomer is trimethoxysilyl propyl methacrylate (TPM).

In some embodiments, the step of contacting comprises polymerizing the crosslinking monomer and an acrylic monomer, thereby forming a polymer (e.g., an acrylic polymer and/or the composite).

In some embodiments, the step of contacting comprises contacting a first crosslinking monomer and a second crosslinking monomer, thereby providing a siloxane. In some embodiments, the step of contacting comprises contacting a first crosslinking monomer and a second crosslinking monomer in the presence of water, thereby hydrolyzing the first crosslinking monomer and the second crosslinking monomer and providing a siloxane.

In some embodiments, the monomer mixture comprises about 50% to about 99.9% by weight of the acrylic monomer. In some embodiments, the monomer mixture comprises about 70% to about 99% by weight of the acrylic monomer.

In some embodiments, the monomer mixture comprises an acrylic monomer comprising an acrylic group (e.g., a polymerizable functional group). In some embodiments, the acrylic monomer is selected from the group consisting of acrylamide, methacrylamide, acrylic acid, methacrylic acid, alkyl acrylate, alkyl methacrylate, and any combination thereof. In certain preferred embodiments, the acrylic monomer is acrylamide.

In some embodiments, the monomer mixture comprises a bifunctional monomer (e.g., a bisacrylic monomer). In some embodiments, the bifunctional monomer (e.g., a bisacrylic monomer) comprises two functional groups (e.g., polymerizable functional groups). In some embodiments, the bifunctional monomer is selected from the group consisting of divinyl sulfone (DVS), epichlorohydrin, glutaraldehyde, glyoxal, and genipin.

In some embodiments, the monomer mixture comprises a bisacrylic monomer comprising two acrylic groups (e.g., polymerizable functional groups) that each form a portion of the acrylic polymer. In some embodiments, the bisacrylic monomer is selected from the group consisting of methylenebisacrylamide (MBAM), N,N′-ethylenebisacrylamide (EBAM), N,N′-bisacryloyl cystamine (BAC), N,N′-bis(acryloyl) ethylene diamine (BAED), polyethylene glycol diacrylate (PEGDA), 1,4-butanediol diacrylate (BDDA), and any combination thereof. In certain preferred embodiments, the bisacrylic monomer is methylenebisacrylamide (MBAM).

In some embodiments, the monomer mixture comprises about 0.1 wt % to about 10 wt % of the bifunctional monomer (e.g., bisacrylic monomer). In some embodiments, the monomer mixture comprises about 0.5 wt % to about 5 wt % of the bifunctional monomer.

In some embodiments, the method comprises a step of drying the composite. In some embodiments, the step of drying comprises heating the composite to a temperature of about 30° C. to about 80° C. (e.g., about 40° C.).

In some embodiments, the method comprises a step of crushing (e.g., grinding, compressing, and/or pressing) the composite. In some embodiments, the method comprises a step of crushing (e.g., grinding, compressing, and/or pressing) the composite, thereby forming a powdered composite.

In some embodiments, the disclosure provides a method of preparing a cementitious composition comprising: combining an organic-inorganic composite as described herein and a cementitious material.

In some embodiments, the cementitious material is selected from the group consisting of cement, slag, supplementary cementitious material, and any combination thereof. In certain preferred embodiments, the cementitious material is cement.

In some embodiments, the method comprises combining water with the composite and the cementitious material. In some embodiments, the method comprises mixing the water, the composite, and the cementitious material. In some embodiments, the step of combining water, the composite, and the cementitious material comprises dissolving a siloxane (Si—O—Si) present in the composite.

In some embodiments, the method comprises combining an aggregate with the composite, the cementitious material, and water. In some embodiments, the step of combining water, the composite, the cementitious material, and the aggregate comprises dissolving a siloxane (Si—O—Si) present in the composite. In some embodiments, the aggregate is selected from the group consisting of sand, gravel, stone, and any combination thereof. In some embodiments, the method comprises mixing the water, the composite, the cementitious material, and the aggregate.

In some embodiments, the organic-inorganic composite as described herein comprises a dissolvable siloxane (Si—O—Si) component.

In some embodiments, the organic-inorganic composite as described herein provides calcium silicate hydrate (C-S-H). For example, the organic-inorganic composite may react with a cementitious material to provide (e.g., nucleate and/or grow) C-S-H. Additionally, the organic-inorganic composite as described herein, for example, may increase the amount, density, and morphology of C-S-H.

In some embodiments, the organic-inorganic composite as described herein acts as a C-S-H seeding/nucleating agent, an air entraining agent, and/or an internal curing agent in a cementitious composition. In some embodiments, the organic-inorganic composite as described herein acts as a C-S-H seeding/nucleating agent, thereby providing C-S-H by a nucleation-dominated hydrate growth. In some embodiments, the organic-inorganic composite as described herein acts as a C-S-H seeding agent by providing C-S-H in nucleation-dominated hydrate growth. The nucleation-dominated hydrate growth, for example, includes uniform phase nucleation that is not interface-dominated. In some embodiments, the organic-inorganic composite as described herein acts as an internal curing agent by releasing water through siloxane dissolution.

In some embodiments, the cementitious composition comprises voids, such as macrovoids. In some embodiments, the organic-inorganic composite as described herein minimizes overall macrovoid volume in a cementitious composition. In some embodiments, the macrovoids of the cementitious composition comprise composite and C—H (calcium hydroxide) and/or C-S-H.

In some embodiments, the organic-inorganic composite as described herein is useful as a microstructural refinement additive, strengthener, and/or seed release agent in a cementitious composition (e.g., a cement paste or concrete).

In some embodiments, the organic-inorganic composite as described herein is useful in infrastructure applications. For example, the composite may be used in concrete for building bridge decks or pylons for piers.

In some embodiments, the organic-inorganic composite as described herein is useful in biological and/or biomedical applications. For example, the composite may be used in polymeric biomaterials intended to facilitate the growth of hard tissues in orthopedic and dental applications as well as polymer-based drug delivery agents. In another example, the composite may be used in nanocomposites that better mimic properties of natural biocomposites, such as shells, coral, and bone.

### EXAMPLES

The examples and preparations provided below further illustrate and exemplify particular aspects of embodiments of the disclosure. It is to be understood that the scope of the present disclosure is not limited in any way by the scope of the following examples.

### Example 1

### Materials and Methods

### Hydrogel Synthesis:

Hydrogel particles were synthesized through solution, free-radical polymerization methods. Acrylamide (AM, monomer), N,N′-methylenebisacrylamide (MBAM, crosslinker), 3-trimethoxysilyl propyl methacrylate (TPM, siloxane crosslinker and silicate precursor), sodium metabisulfate (NaS₂O₅), and sodium persulfate (NaS₂O₈) were purchased from Sigma-Aldrich (St. Louis, MO) and used as received.

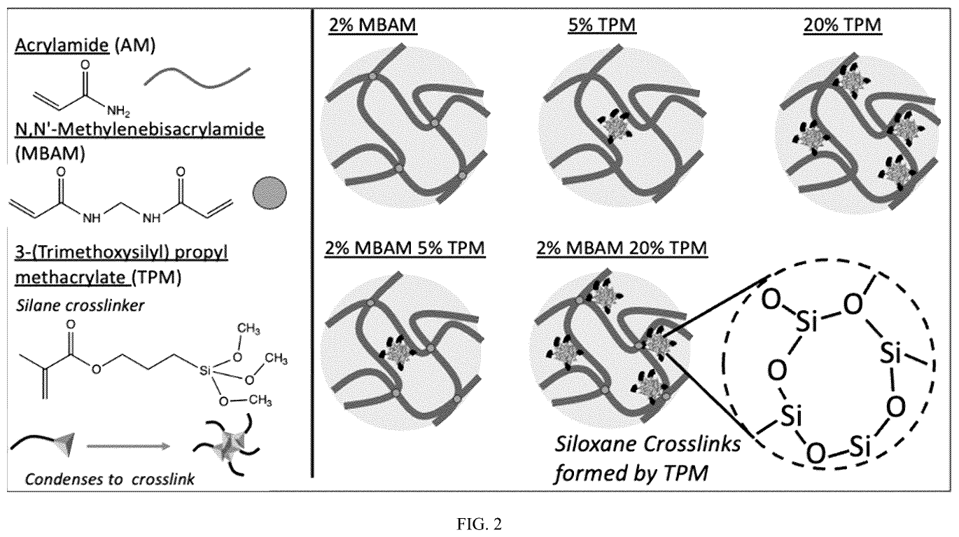

MBAM crosslinker solutions were prepared by mixing 0.3 g of MBAM with 20 mL of DI water (0.1 M). Separate initiator solutions were prepared by mixing 0.3 g of Na₂S₂O₅ and Na₂S₂O₈ to 10 mL of DI water. Five different gel compositions were synthesized (Table 1, FIG. 2), MBAM crosslinked gels, MBAM and TPM crosslinked gels, TPM crosslinked gels. Two dosages of TPM were investigated: 5% and 20% by mass of total monomer. When necessary, 4 mL of a MBAM crosslinker solution was added to a total MBAM loading of 2% by weight of monomer (AM+TPM).

First, AM and TPM monomer were mixed in 7 mL of water in 20 mL scintillation vials. TPM is immiscible is water and forms large droplets when mixed in the monomer solution. Each vial was vigorously shaken to disperse the TPM droplets. When necessary, MBAM crosslinker solution was added. Finally, 0.5 mL of each initiator solution was added to initiate polymerization for all gel compositions. All syntheses were carried out at room temperature on a magnetic stir plate and allowed to stir for 24 hours to ensure complete gelation and free radical termination. At some point, gelation would prevent the magnetic stir bar from spinning. Following gelation, hydrogels were removed from vials and dried in an oven at 40° C. till dry. Dry gels were ground in a coffee grinder to produce the powdered admixtures.

TABLE 1
Hydrogel compositions.

| | AM | TPM^{a} | H₂O | MBAM soln. | Monomer/solvent |
|---|---|---|---|---|---|
| Hydrogel | (g) | (mL) | (mL) | (mL) | (g/g)* |
| 2% MBAM | 3 | 0 | 12 | 4 | 0.255 |
| 5% TPM | 2.85 | 0.144 | 8 | 0 | 0.375 |
| 20% TPM | 2.4 | 0.574 | 8 | 0 | 0.375 |
| 2% MBAM | 2.85 | 0.144 | 12 | 4 | 0.255 |
| 5% TPM | | | | | |
| 2% MBAM | 2.4 | 0.574 | 12 | 4 | 0.255 |
| 20% TPM | | | | | |

*Total monomer content includes the mass of AM, TPM, and MBAM.
^{a}density of TPM is 1.045 g/mL

### Fourier Transform Infrared Spectroscopy:

A PerkinElmer Spectrum 100 FT-IR was utilized to verify copolymerization of AM and TPM. Spectra for wet, as-synthesized, hydrogel samples were characterized over a range of 4000-600 cm⁻¹. 64 scans were performed per sample to increase the signal to noise ratio and each spectrum was background corrected. A spectrum of uncrosslinked, linear, polyacrylamide (PAM) was also collected to provide reference for the TPM crosslinked gels. Spectra were baseline corrected in OriginPro software (OriginLab, Northampton, MA).

### Preliminary Gel Synthesis and Swelling Experiments:

Hydrogels were synthesized in scintillation vials and imaged. 2% MBAM, 2% MBAM 5% TPM, and two samples of 2% MBAM 20% TPM gels were synthesized in 40 mL scintillation vials. The 2% MBAM 20% TPM gels were stirred at a low and high rate while gelling to vary the dispersion of immiscible TPM within the gelling polymer solution. Cement pore solution was prepared by adding tap water to Type I cement powder at a 10/1 ratio and stirring. The mixture was allowed to rest for 30 minutes to allow for cement particle settling and dissolution. Ion-rich pore fluid was decanted from the top of the mixture into the vials. Gels were allowed to swell in the pore solution for 35 days.

Samples of all gel compositions were synthesized in 40 mL scintillation vials. A supersaturated 13.1 pH Calcium Hydroxide solution was prepared by mixing 80 g of Ca(OH)2 and 10 g of NaOH in 1000 mL of water for 45 minutes. The solution was poured over the gels and allowed to sit for 7 days.

### Gravimetric Swelling Tests:

The tea-bag method was utilized to characterize the swelling behavior of dried, powdered, hydrogels in both DI water, cement pore solution, and basic NaOH solution. Pore fluid was prepared as above. For the basic solution, roughly 4 g of NaOH pellets were added to 1 L of water and additional pellets were added until a pH meter produced a reading of 13 for the solution.

For each swelling test, a teabag was submerged in fluid before being patted till only damp with a paper towel. The mass of the damp bag was recorded (mbag). 0.2 grams of dry hydrogel powder were placed in each teabag before immersing in fluid and allowed to swell. Teabags were removed, patted till damp, and weighed (mswelled) after 2,4, and 24 hours of swelling. The pH of the pore solution was also measured at each interval. Each swelling test was performed in triplicate and averaged. The swelling ratio, Q (grams of absorbed fluid per grams of dry hydrogel), was calculated for each gel composition according to the formula below.

$$Q = \frac{{m}_{s w e l l e d} - {m}_{b a g} - {m}_{d r y}}{{m}_{d r y}}$$

Swelling data in the pH 13 NaOH solution was only collected on 5% TPM and 20% TPM gels and only after 24 hours of swelling.

### Small Angle X-Ray Scattering:

Physical structure of the hydrogels was characterized through x-ray scattering experiments on an AntonPaar SAXSpoint 2.0 with a Primus 100 Cu K-a x-ray source and a Dectris Eiger RIM detector.

Wet, as-synthesized, hydrogels were sealed in Kapton tape envelopes and placed between the two metal plates of the 5×4 solids sample holder. Additional double-sided tape was used to seal the metal plates to each other, ensuring that the swelled hydrogels were not vacuum dried during measurement. Each gel sample was irradiated for 3 frames of 30 seconds each. A background Kapton sample was also collected. 2D frames were averaged, reduced to 1D, background corrected, and normalized by transmittance using SAXSAnalysis software (AntonPaar). The resulting data was plotted using SASView software.

### Rheometry:

Gelation behavior of the TPM crosslinked gels was characterized through oscillatory shear measurements in an AntonPaar MCR 702 rheometer using the CC-10 concentric cylinder geometry. AM-TPM solutions were prepared as described above and initiator solutions were added just before being loaded into the rheometer attachment. Polymerizing and gelling samples were pre-sheared at a rate of 100 s⁻¹ for 1 min before being allowed to rest for 2 mins. Samples were sheared for 0.1% strain at an angular frequency of 10 rad/s while measuring storage (G′) and loss modulus (G″). The test was allowed to run overnight to complete gelation and samples were covered to minimize evaporation. The time till the G′-G″ crossover point was used as the time until gelation.

### Batch Mixing of Cement Paste and Secondary Electron Scanning Electron Microscopy (SEM):

Dried hydrogel powder was mixed into cement paste to characterize the effects of varying gel chemistry on cured cement paste microstructure. Typical hydrogel loadings in cement are around 0.2% by weight of cement however a higher loading of 1% was used in order to get ample examples of hydrogel-cement interactions. The water/cement (w/c) of 0.42 was set for each mixture.

0.2 g of dry hydrogel powder was mixed with 20 grams of cement powder using a spatula. 8.4 grams of tap water was added before the mixture was mixed with a Kitchen Aid hand mixer for 60 s. The sizes of the container were scraped down before mixing for another 60 s. Mixtures were cast in plastic centrifuge tube molds that were sprayed with silicone mold release and allowed to cure for 3 days. Subsequently, samples were removed and submerged in isopropanol, and vacuum dried at 60° C. for 72 hours to arrest hydration. Cement paste samples were vacuum impregnated with a low-viscosity epoxy (Ted Pella Inc., Redding, California) which was cured overnight at 60° C.

Cured samples were sectioned using a diamond saw and polished till a grit of 6 μm diamond paste with propylene glycol lubricant. Samples were ultrasonicated in isopropanol between polishing grits.

Polished samples were carbon coated and imaged using a Quanta 650 FEG scanning electron microscope (SEM) operating at 10.00 kV. An EDAX Silicon Drift Detector was used to collect elemental composition information through energy dispersive spectra (EDS). At least 60 micrographs of hydrogels within the cement microstructure were collected per hydrogel composition to provide a representative view of hydrogel chemistry effects on cement paste morphology.

### Cryogenic SEM:

A Thermo Scientific Apero 2 scanning electron microscope was utilized in cryogenic mode (cryoSEM) to characterize the hydrated structure of the gels and early hydration behavior of the gel-cement interface. Hydrated samples were sectioned with a razor blade and placed on a sample sled using a 2-part adhesive consisting of Aquadog graphite and optical cutting temperature compound. Hydrated samples were flash frozen by submerging in just-melted liquid nitrogen slush. Following freezing, samples were fractured to provide a fresh imaging surface, sublimed for 4 minutes to expose the frozen structure, and coated with platinum. Samples were imaged in secondary electron mode on a nitrogen-cooled stage. Elemental spectra of the samples were analyzed with an Oxford Instruments Ultim Max EDX detector.

Gels for cryogenic scanning electron microscopy were polymerized inside a syringe to produce cylinders of gel that were sectioned into discs after gelation (diameter ˜12 mm, height ˜1 mm). Discs were dried in an oven overnight at 40° C. Dried gel disks were swelled in DI water for 24 hours and imaged in the cryoSEM to characterize their structure. Subsequently, dried gel discs were swelled in pH 12 cementitious pore fluid for 24 hours and imaged in the cryoSEM to study the effects of a basic cementitious environment. Furthermore, cryoSEM was used to characterize interactions between the hydrogels and wet cement paste over time. Cement paste was prepared with a water to cement ratio (w/c) of 0.42. Dried gel discs were swelled in DI water overnight, removed from the liquid, patted dry, and smeared with a thin layer cement paste. The subsequent assemblies were wrapped in parafilm, placed in a sealed container, and allowed to cure for 3, 18, and 21 hours. The wet gel-cement composite was frozen and fractured; the interface was imaged with cryoSEM. Only the gels containing MBAM crosslinks (2M, 2M5T, 2M20T) were imaged after the pore fluid and cement paste interface treatment. TPM crosslinked gels (5T, 20T) dissolved quickly after contact with the cementitious mixtures and were impossible to image accurately in the cryoSEM. C-S-H and other hydrates were identified through morphological comparison with literature and EDS elemental confirmation.

### Example 2

### Gel Synthesis and Characterization

Macro images of the hydrogels are shown in FIG. 3. In the two samples with 20% TPM, silane bubble condensation and opacity were visible. 5% TPM and 20% TPM gels remained suspended when inverted with no other chemical crosslinker providing evidence that TPM can crosslink polyacrylamide into a hydrogel.

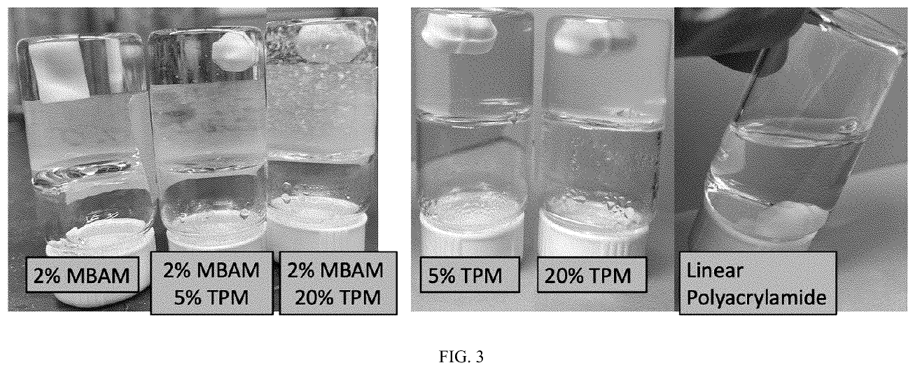

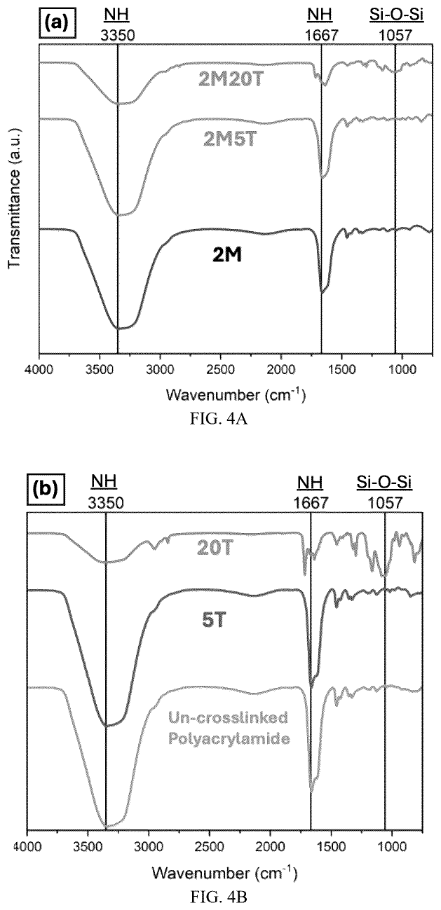

FTIR spectra are reported in FIGS. 4A and 4B. Peaks at 3350 cm⁻¹ and 1667 cm⁻¹, which are indicative of the NH bond within polyacrylamide, were present in all spectra. Clear peaks around 1057 cm⁻¹ indicative of siloxane bonds appeared when TPM loading was increased to 20%. The appearance of the 1057 cm⁻¹ peak along with the gelation of 5% TPM and 20% TPM without MBAM provide support of successful polymerization and crosslinking of polyacrylamide by TPM.

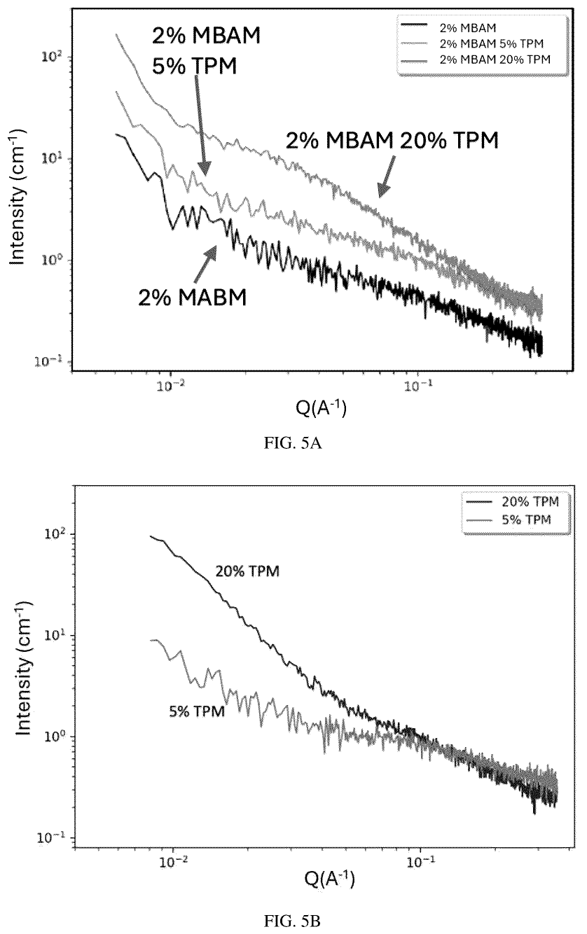

SAXS patterns are reported in FIGS. 5A and 5B. All SAXS plots showed increasing slopes with increasing crosslinker content. For samples with TPM, the data in the low Q range overlapped. Higher slopes in the low Q region with increasing crosslinker content is indicative of increased polymer packing and density.

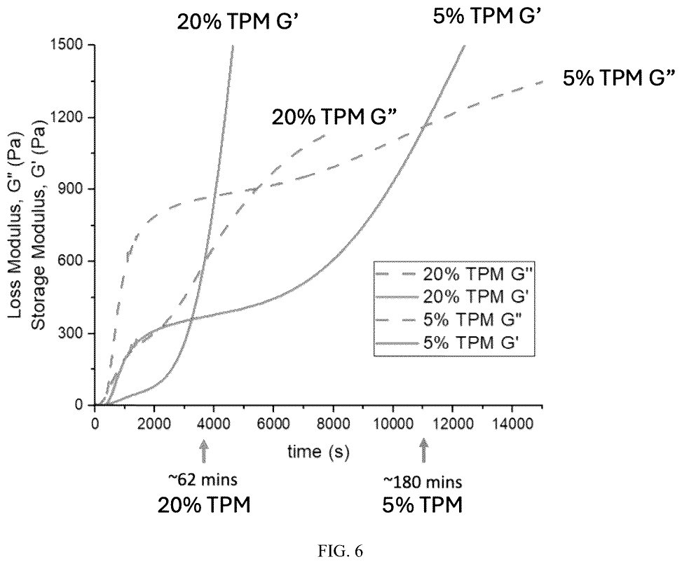

Rheometry results are reported in FIG. 6. Rheological analysis provided further evidence to support the formation of siloxane crosslinks. A greater storage modulus (G′) than loss modulus (G″) indicates the transition from a liquid solution to a solid gel. The 5% TPM sample had less crosslinker and took about three times longer to reach the crossover gel point as the 20% TPM sample.

### Example 3

### Swelling Tests

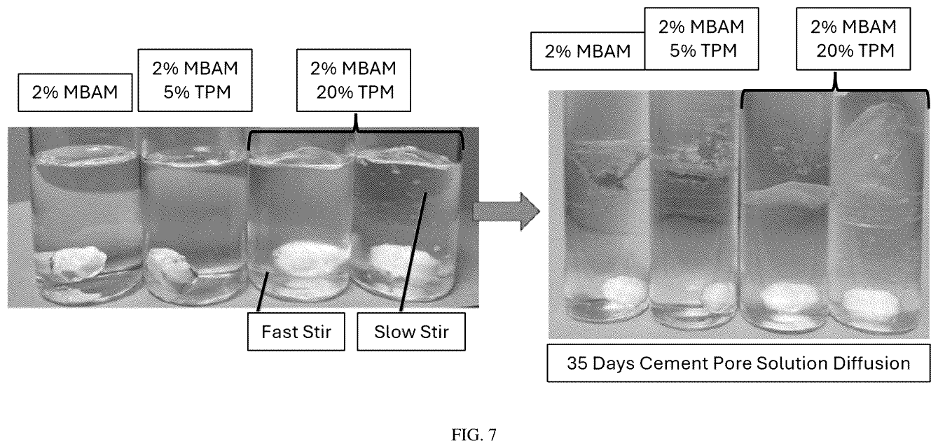

The results from FIG. 7 provide further evidence to support that TPM was able to crosslink the hydrogel. With increasing TPM loading, the gels swelled less over the 35 days. The two samples of 2% MBAM 20% TPM in FIG. 7 showed that morphological control of the siloxane crosslinks could be achieved through a simple method of varying the stir rate. Further there is evidence that the less dispersed, larger siloxane agglomerates effectively crosslinked the gel less as this gel swelled more than the fast-stirred, well dispersed TPM gel.

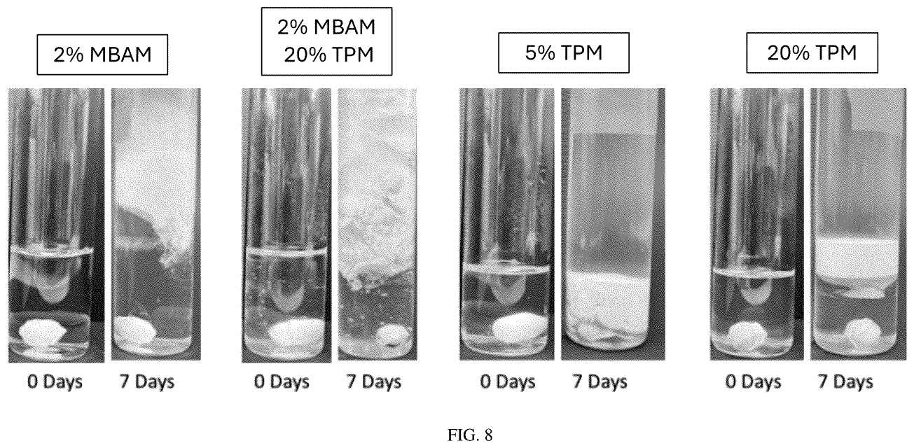

Siloxane crosslinks showed evidence of dissolving when swelled in pH 13.1 supersaturated Ca(OH)₂ for 7 days (FIG. 8). The 5% TPM gel appeared to be deswollen under the layer of undissolved powder however, it completely dissolved into a viscous polymer solution when disturbed. Conversely, the 20% TPM gel only showed slight evidence of dissolution. The 2% MBAM 20% TPM sample, fractured and swelled to the top of the vial. This behavior was similar to the results from FIG. 7 where a gel of the same composition fractured while swelling. The fractured gel was likely due to the dissolution of siloxane crosslinks, MBAM crosslinks remained allowing the gel to remain partially intact. The increased swelling behavior of the polyacrylamide gel is likely due to its hydrolysis in a basic medium.

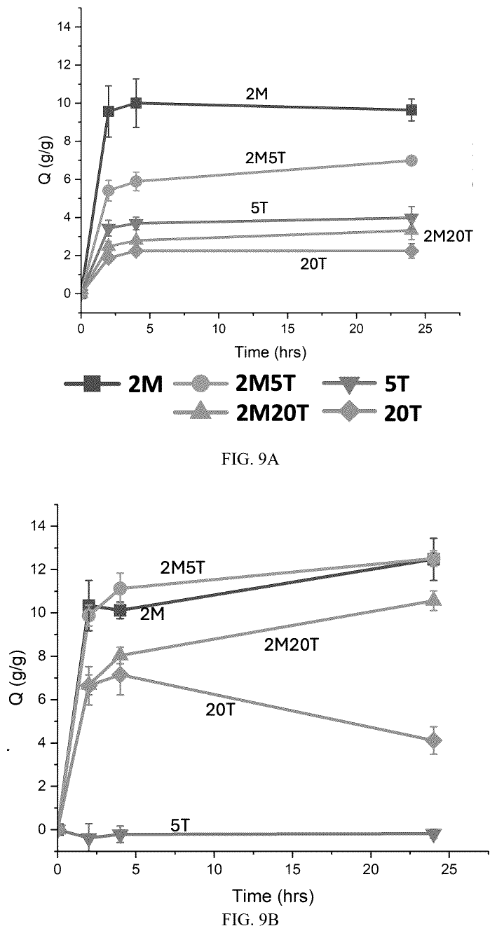

Gravimetric swelling tests were performed to understand the swelling kinetics and capacity of the hydrogel compositions in DI water and cementitious pore fluid. Specifically, the differences between the swelling behavior in neutral solution and ˜pH 12 pore solution showed the dynamic behavior of the hydrogels. The results are reported in FIGS. 9A and 9B.

The 5% TPM gels dissolved completely within two hours of swelling leaving an empty tea bag, and displaying a Q (swelling ratio) of zero in FIG. 9B. 20% TPM gels began to show evidence of dissolution between 4 and 24 hours. This behavior is visually supported by FIG. 8. 2% MBAM gels in pore solution had a higher swelling ratio than those in DI water likely due to hydrolysis of polyacrylamide. Hydrogels with MBAM and TPM swelled much more in pore solution than in DI water. This shows the combined effect of dissolving siloxane crosslinks and PAM hydrolysis. After 24 hours, 2% MBAM and 2% MBAM 5% TPM gels swelled to the same extent. Once the siloxane crosslinks dissolved, the gel behaved similarly to the purely MBAM crosslinked gel (2% MBAM). When 5% TPM and 20% TPM dried gels were swelling in pH 13 solution they both completely dissolved within 24 hours.

In DI water (FIG. 9A) all hydrogel compositions reached their equilibrium swelling capacity after 2 hours and maintained that value for the full 24 hours. Additionally, the hydrogels displayed decreased swelling with increasing TPM loading/siloxane crosslinking. The purely TPM crosslinked gels swelled less than their MBAM crosslinked counterparts with the same TPM loading.

The hydrogels' equilibrium swelling capacity and kinetics were different in pore fluid (FIG. 9B) than in DI water. The 2M gel with no TPM showed a slightly increased swelling capacity. Likewise, the MBAM and TPM crosslinked gels (2M5T, 2M20T) showed a dramatic increase in swelling capacity in pore fluid with 2M5T even reaching the swelling capacity of the 2M hydrogel. The 5T gel completely dissolved within the first two hours of the test, leaving an empty teabag. This is indicated by a swelling capacity of 0 shown on the plot in FIG. 9B. Siloxane bonds, which crosslink the 5T and 20T gels are known to dissolve in basic solution. Likewise, the 20T showed decreasing value of Q after 4 hours, likely due to siloxane crosslink dissolution.

TABLE 2
Pore solution pH values at swelling test intervals

| Time (hr) | 0 | 2 | 4 | 24 |
|---|---|---|---|---|
| Pore soln. pH | 12.15 | 12.11 | 12.14 | 12.01 |

### Example 4

### Secondary Electron Scanning Electron Microscopy (SEM)

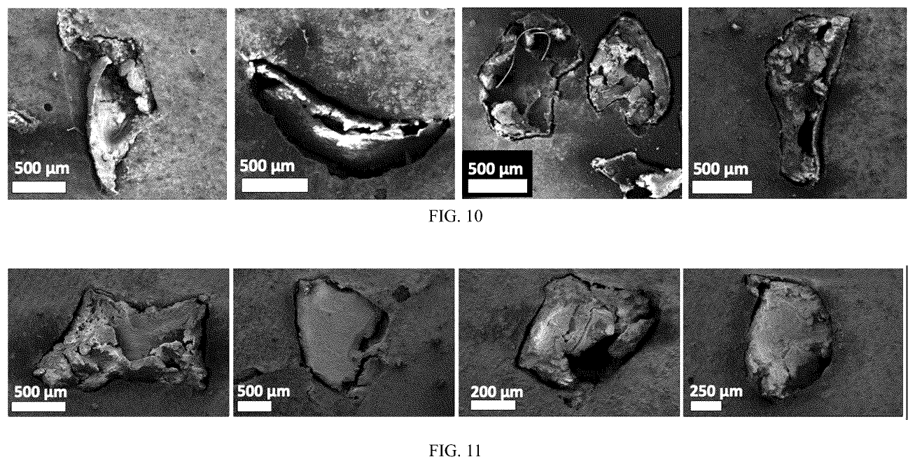

Post cement curing and sample drying, the hydrogels were dehydrated and de-swelled. Representative SEM images are shown in FIGS. 10, 11, 12A, 12B, 13, and 14. FIGS. 15A to 15E show a comparative selection of SEM images.

De-swelled 2M (FIG. 10) was often seen crumpled within the cement leaving behind a macrovoids, a common drawback of hydrogels in internally cured cement.

In FIGS. 10 and 11, 2% MBAM and 2% MBAM 5% TPM gels were clearly seen deswollen in the cement paste. The deswollen, dried gels exhibited an aggregated behavior within the voids. Some voids also showed the gel delaminating from the walls of the void. With the addition of 5% TPM the gels showed greater void fill-in behavior than the pure 2% MBAM gels. Some still had the aggregated morphology similar to 2% MBAM.

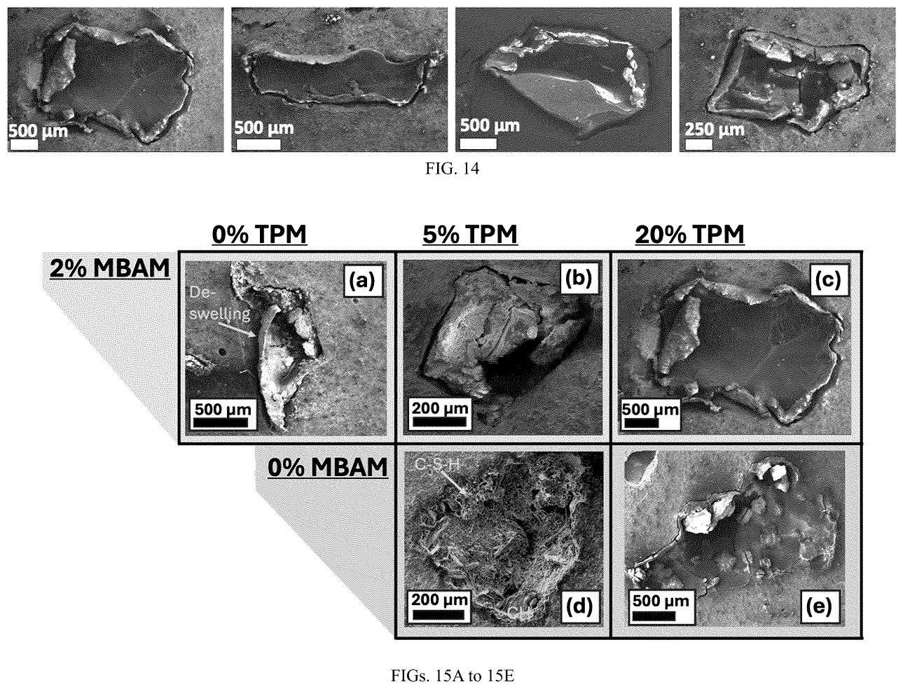

2M5T (FIGS. 11) and 2M20T (FIG. 14) gels showed some evidence of deswelling as their edges visually disconnected/curled away from the walls of the cement matrix. However, deswelling in the silane loaded gels was less pronounced than the 2M silane free gel and led to an overall reduction in macrovoid volume.

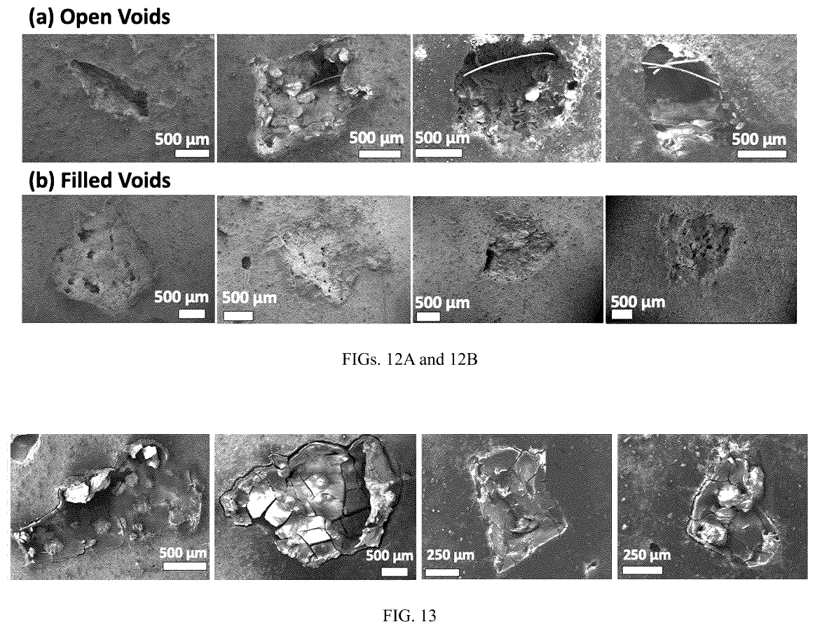

As shown in FIG. 12, conversely, 5% TPM gels with no MBAM displayed two different behaviors. The 5T gels often completely dissolved within the cement paste, leaving behind open macrovoids with hexagonal calcium hydroxide (CH) platelets and “honeycomb” C-S-H with no visual evidence of deswollen residual hydrogel (FIG. 12A). Other voids appeared to be completely filled in (FIG. 12B). Both these behaviors can be explained by the complete dissolution of the 5% TPM gels shown in FIGS. 8, 9A, and 9B. Without being bound by any theory, if the gel dissolves early during cement hydration, perhaps it releases enough free silicate and free volume for the cement to fill in with hydrates. If the gel dissolves later, it leaves behind a stabilized pore.

As shown in FIG. 13, 20% TPM gels were shown to swell the least in FIGS. 9A and 9B (among the undissolved gels) and this was observed in the microstructures as well. The 20T gels displayed a hard, glassy, morphology in the cement microstructure with no evidence of swelling, deswelling, or dissolving at the matrix walls (FIG. 13). The voids were observed to be filled, the polymer within the gel displayed a fractured “glassy” surface.

As shown in FIG. 14, 2% MBAM 20% TPM gels showed more evidence of swelling than the pure 20% TPM gels, this is also supported by the earlier swelling test. Their morphology also showed void-fill in behavior similar to the 2% MBAM 5% TPM gels, however, the product was visually similar to the glassy product shown by the 20% TPM gels. In the third image, polishing lines are visible on the surface of the fill-in product indicating a hard surface.

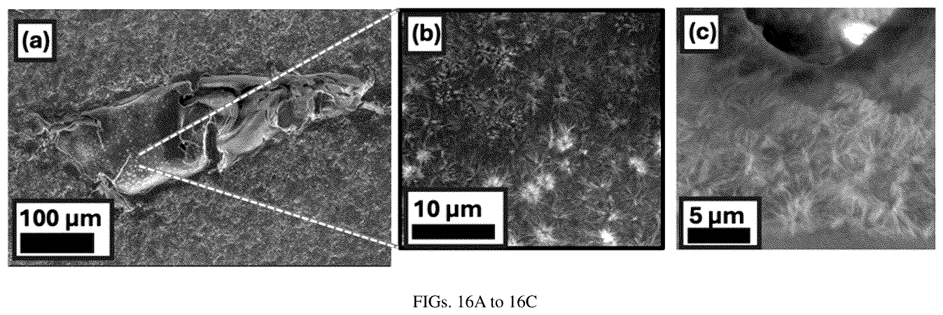

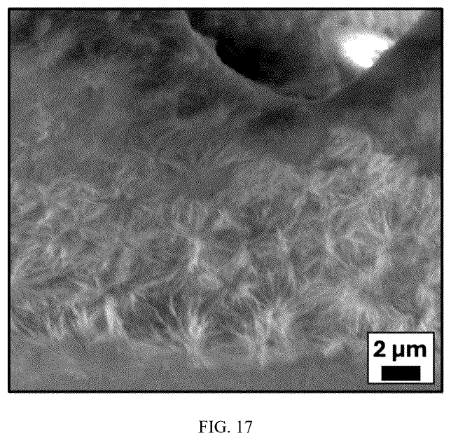

Many of the 20T gels in cement paste displayed a fine, hairlike, inorganic product growing on their surface (FIGS. 16A to 16C and 17). The needlelike phase is morphologically similar to SEM images of calcium silicate hydrate (C-S-H) found in literature. C-S-H is the main strengthening phase of cement. EDS scans of the needlelike phase were dominated by Silicon and Calcium with an absence of Sulphur indicating that the phase is likely C-S-H and not a different needlelike cementitious phase, ettringite. This needlelike C-S-H is morphologically like the needlelike C-S-H growing off the 2M20T gel-cement interface in FIG. 23C. EDS point scans of the inorganic phases were dominated by calcium and silicon in the absence of sulfur signals indicating that the phase was C-S-H.

### Example 5

### Hydrogel Structural Characterization through CryoSEM

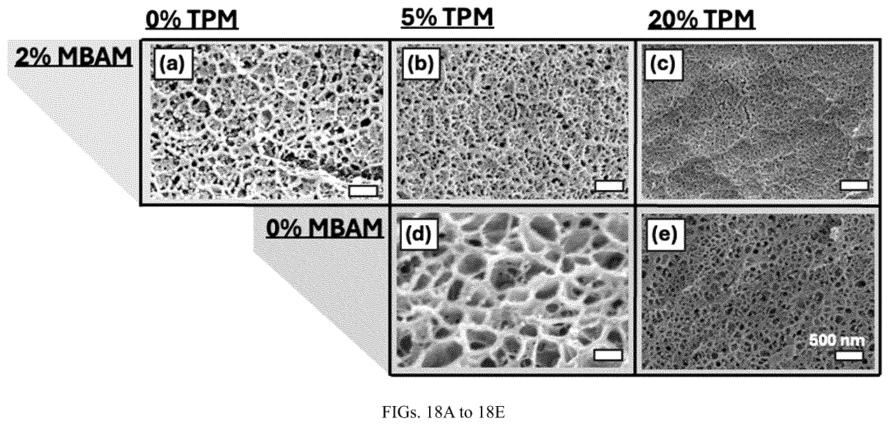

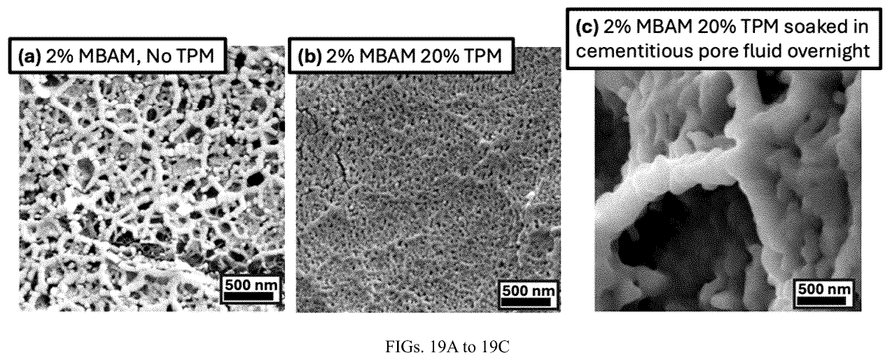

CryoSEM offered insights into the microstructure of the swollen hydrogels (FIGS. 18A to 18E). Broadly, the hydrogels displayed a sponge-like porous structure, denser with increasing crosslinking (FIGS. 18A to 18E, 19A, and 19B).

Cryogenic SEM (Cryo-SEM) allows an investigation of the hydrogel's internal structure while swelled. 2% MBAM gels (FIG. 19A) showed a dense interconnected network with pores ˜100s of nm. With the addition of 20% TPM in the composition (FIG. 19B), the network became denser with a reduction of the pore size to ˜10s of nm. Swelling the 2% MBAM 20% TPM gels in basic cementitious pore solution resulted in a wide, open, network visually showing the ability of TPM crosslinks to dissolve in basic cementitious systems (FIG. 19C).

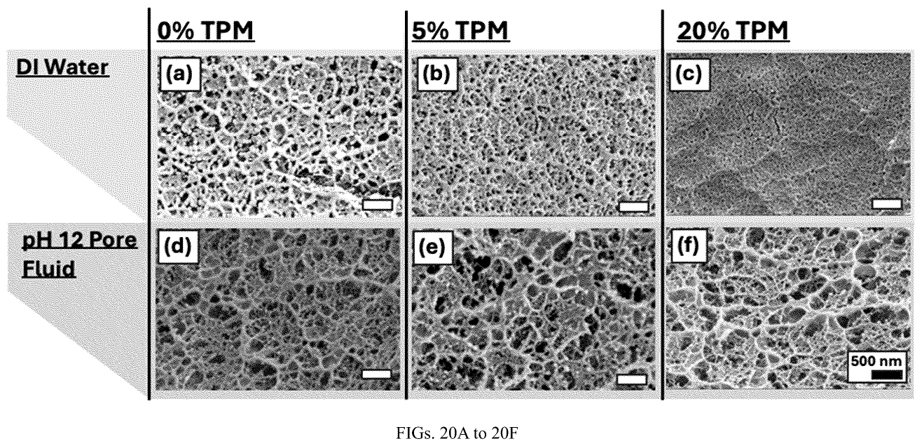

The structural changes of the hydrogels in pore fluid seen through cryoSEM (FIGS. 20A to 20F) further illuminate the swelling test results (FIG. 9B). The 2M gel in pore fluid (FIG. 20D) showed a more open structure than in DI water (FIG. 20A). Likewise, 2M5T (FIG. 20E) and 2M20T (FIG. 20F) were less dense than their counterparts in DI water (FIGS. 20B and 20C). All gels swelled in pore fluid for 24 hours displayed approximately the same structure.

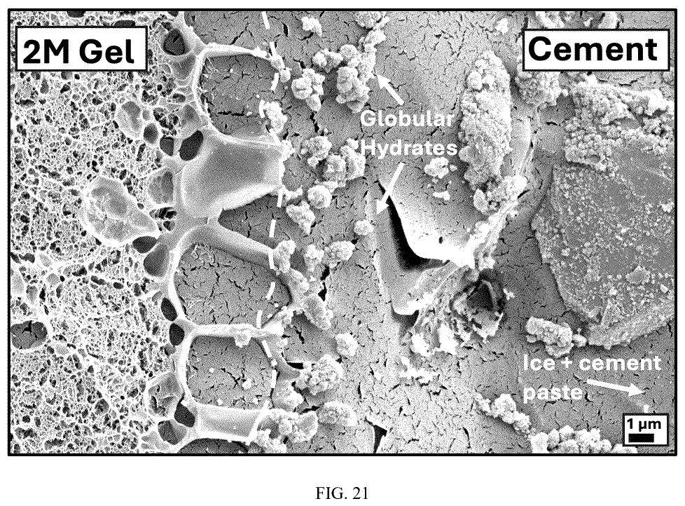

CryoSEM allowed for the investigation of hydrated, swelled, gels and pre-cured cement paste interactions. Specifically, cryoSEM illuminated the effects of hydrogel chemistry on early-age cementitious phase nucleation. Distinct, globular, “interface-dominated”, hydrate nucleation was visible near the interface of the 2M gel and cement paste after 3 hours (FIG. 21).

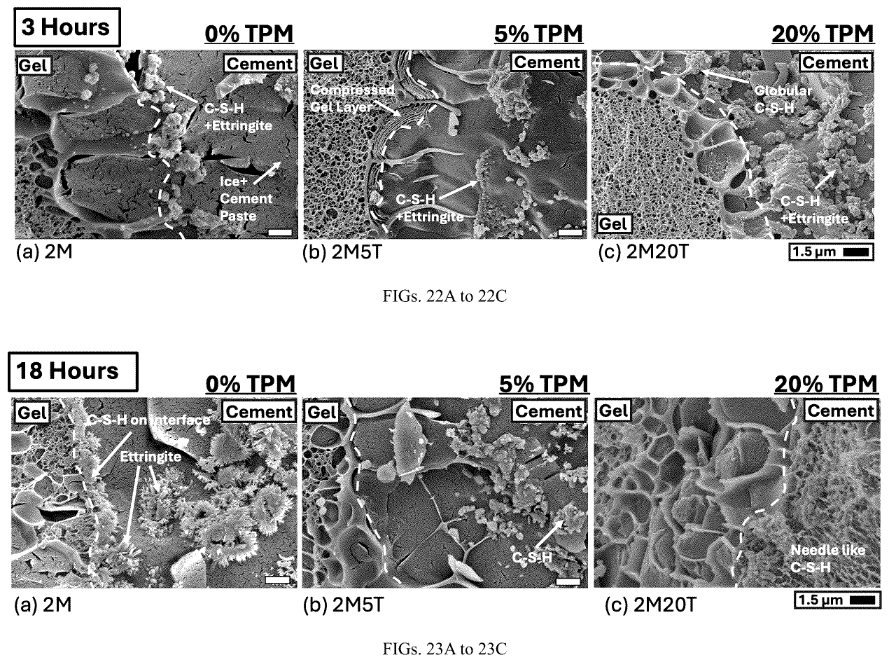

In FIG. 22A, C-S-H and ettringite, a sulfur-based cementitious hydrate, is visible growing on the 2M gel-cement interface as in FIG. 21. Phases were confirmed through morphological comparison with literature and EDS point scans. Compared to 2M (FIGS. 21 and 22A) interface-dominated nucleation was not visible for the silica functionalized gels (FIGS. 22B and 22C). The 2M5T gel-cement interface (FIG. 22B) had visible C-S-H and ettringite, but it was diminished compared to the 2M sample and appeared ˜6 μm from the interface. A layer of collapsed gel was also visible at the interface. Conversely, the 2M20T sample (FIG. 22C) showed increased and uniform phase nucleation, neither interface-dominated nor far from the interface.

The phase nucleation trends are similar after 18 hours as seen in FIGS. 23A to 23C. The 2M gel (FIG. 23A) once again displayed interface-dominated nucleation, however, after 18 hours the hydrates had grown into coarse, branching patches. Again, the 2M5T gel (FIG. 23B) appeared to have diminished hydrate growth that was far from the interface. The 2M20T gel (FIG. 23C) once again had increased phase nucleation. The 2M20T sample at 18 hours displayed needlelike C-S-H growing on the cement and fine needlelike product growing on the gel.

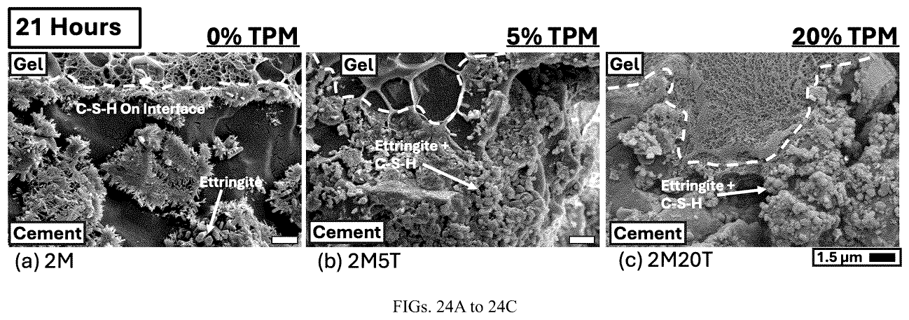

After 21 hours, the 2M sample continued to show interface-dominated and coarse, branching, patches of hydrate growth (FIG. 24A). Both 2M5T and 2M20T (FIGS. 24B and 24C) had increased phase nucleation compared to 2M. The hydrate morphology at the 2M5T and 2M20T interfaces was dense and globular compared to the branching patches seen with 2M.

### Example 6

### Discussion

### Structure and Swelling Kinetics of Hydrogels in DI Water

The swelling behavior of hydrogels in DI water (FIG. 9A) was as expected. Increasing crosslinking, generally, will decrease the swelling capacity of a hydrogel. However, the TPM-only crosslinked hydrogels swelled less than their counterparts containing both TPM and MBAM crosslinks. This is likely due to the different crosslinking and gelation mechanisms that the two classes of gels have. TPM crosslinking and gelation is dependent on the rate of hydrolysis and condensation of the Si end. Additionally, TPM is immiscible in water until it hydrolyses and forms small droplets in solution during hydrogel preparation. These droplets shrink as TPM hydrolyses, releasing molecules into the polymerizing polyacrylamide solution. The released TPM molecules undergo free radical polymerization through their organic end and siloxane condensation through their silica end. In the TPM only crosslinked gels, gelation is dependent on enough of the TPM to hydrolyze and polymerize with PAM to form a crosslinked network. However, gelation in the MBAM containing gels is quicker as it is not dependent only on TPM hydrolysis, miscibility, condensation, and polymerization. The MBAM containing solutions can reach gelation sooner, leaving unhydrolyzed TPM suspended in droplets within the solid gel. TPM droplets will eventually condense and may polymerize with PAM as the free radicals in solution terminate, however, they will not crosslink as efficiently as the MBAM in the same gel. This means that the same amount of TPM will lead to less crosslinks when a more efficient crosslinker is present and could explain why the gels with MBAM and TPM swell more than the TPM-only crosslinked gels. Additionally, TPM will further crosslink while the gel is dried. As the drying polymer network shrinks, uncondensed silanol groups will meet and condense. For the hydrogels that are crosslinked with only TPM dispersed throughout the network, this additional crosslinking during drying could lead to a lower swelling ratio when reswelled and further explains their lower swelling ratio when compared to their MBAM crosslinked counterparts with the same TPM loading.

Any variation in TPM dispersion and crosslinking with and without MBAM is not visible in the cryoSEM micrographs in FIGS. 18A to 18E. CryoSEM displays the structure of connected domains of polymers and does not have the resolution to probe individual crosslinks. CryoSEM does show increasing structural density with increasing crosslinker loading in the gels which has been reported in literature.

### Hydrogel Dissolution in Cementitious Pore Fluid

During the swelling test in pore fluid, the 5T gel dissolved completely, leaving an empty tea bag, and displaying a Q (swelling ratio) of zero in FIG. 9B. Siloxane bonds are well known to dissolve in basic environments (˜pH 12) and is the reason for dissolution and hydration of pozzolanic silica sources in cement. Because the swelling tests were performed gravimetrically, mass loss through gel dissolution appeared as a reduction in swelling ratio. Likewise, the reduction in Q after 4 hours by the 20T gel was interpreted as mass loss due to dissolution of siloxane crosslinks.

MBAM containing gels behaved differently in pore fluid than DI water. The control gel, 2M, showed a slightly increased value of Q. This is likely due to the polyacrylamide being converted to poly acrylic acid through hydrolysis in the basic environment. Repulsion of anionic charges in acrylic acid leads to increased chain repulsion and hydrogel swelling. This also explains the slight increase in pore size seen when comparing the cryo-micrographs of 2M in DI water (FIG. 20A) and pore fluid (FIG. 20D). 2M5T and 2M20T also showed increased swelling in pore fluid likely due to a combination of PAM hydrolysis and siloxane crosslink dissolution. Comparing their cryoSEM structures (FIGS. 20B and 20C with FIGS. 20E and 20F) shows a decrease in gel structure density in pore fluid. After swelling in pore fluid, the MBAM+TPM gels resembled the 2M gel providing evidence that TPM crosslinks dissolve in the basic solution and leave behind the MBAM-linked network. This could also explain why the 2M5T gel showed an equivalent 24-hour swelling ratio to the 2M gel (FIG. 9B). In basic solution, the TPM siloxane crosslinks dissolve leaving the composite gel's structure and swelling properties to be like that of the purely organic gel.

The swelling ratios of the gels of the present disclosure (˜8-12 g/g) are much lower than those reported for hydrogels synthesized purely for internal curing applications in cement (˜200-300 g/g).

Hydrogel Morphology in 3-day Cured Cement Paste

The hydrogel morphology in cured cement paste mirrors the swelling data. Cement pastes with 5T showed many open voids with no evidence of de-swelled hydrogel (FIG. 15D, indicating that the gel dissolved as in the pore fluid swelling test. The open voids were often filled with hexagonal calcium hydroxide (CH) platelets and finer honeycomb-like C-S-H. In previous work, polyacrylamide gels were noted for their ability to encourage the growth of CH. The honeycomb C-S-H seen on the open voids of the 5T gels may have been seeded by the released silica from dissolved siloxane crosslinks. This mechanism of dissolution, which here functions to release C-S-H seeding agents, could be utilized for dosing other beneficial additives during cement curing.

Conversely, 20T did not leave behind open voids like 5T and it was unclear if it dissolved in the cement paste microstructure as it did in pore fluid. The dissolution kinetics may be faster in the pore fluid swelling test because it is in aqueous solution rather than a highly concentrated and confined cement paste. The 20T gels also showed little evidence of de-swelling as the cement matrix cured and hardened.

The silane-free control, 2M, showed behavior typical of a hydrogel in cement paste: de-swelling, and leaving behind a macrovoid. Silane loaded gels with MBAM crosslinks, 2M5T and 2M20T, did not leave behind voids as large as the silane-free 2M gel but still showed potential signs of deswelling as their edges disconnected/curled away from the cement matrix walls. However, the swelling of 2M5T was equivalent to 2M in pore fluid (FIG. 9B). This indicates that a composite organic-alkoxysilane hydrogel could internally cure cement while mitigating overall macrovoid volume. Dissolved siloxane crosslinks potentially re-condensing as the hydrogel releases its water, stabilizing the gel in an expanded state within the cement matrix. Furthermore, the early and late age hydrate nucleation behavior of the silane-functionalized gels could be harnessed to fill macrovoids. The reduction of macrovoid formation through silane-loaded composite hydrogels could be key in improving mechanical properties and durability of high-performance cementitious mixes and specialty applications.

### Early-Age Cementitious Phase Nucleation Behavior

Generally, TPM containing gels showed the ability to nucleate C-S-H at early (18-21 hours) and later ages (3 days) (FIGS. 22B, 22C, 23B, 23C, 24B, and 24C). Needlelike, C-S-H seen in both cryo and standard SEM was morphologically similar to C-S-H in literature, including C-S-H grown directly off of tricalcium silicate powders and early age C-S-H caused by the addition of silanes. The “honeycomb”-like C-S-H viewed on the pore surface left by 5T in cement paste has also been seen in literature.

The cryoSEM results in FIGS. 21, 22A-22C, 23A-23C, and 24A-24C can be understood through nucleation and growth phenomena. Often, phase growth can be either nucleation or growth dominated. In the nucleation dominated case, many small nuclei will form at the expense of growth. Conversely, growth dominated phase formation favors growth of a few stable nuclei over the formation of new ones. C-S-H growth in the 2M gel was concentrated at the gel-cement interface at the earliest ages (FIGS. 21 and 22A-22C). Later, coarse, branching patches indicative of growth-dominated hydrate formation grew on the hydrogel-cement interface and in the cement matrix (FIGS. 23A and 24A). These branching patches resembled early C-S-H seen in cement pastes through cryoSEM in the literature. Large hexagonal columns of ettringite were also seen interspersed with the C-S-H.

The 2M5T sample, with low silane loading, had hydrate nucleation far from the interface at 3 and 18 hours (FIGS. 22B and 23B). 2M5T hydrate growth was diminished at earlier ages when compared to the 2M interfaces. Furthermore, the hydrates exhibited a dense globular structure contrasting with the coarse patches seen with 2M. This behavior is explained through nucleation-dominated hydrate formation. Dissolved TPM crosslinks provide molecular silica groups that act as C-S-H nuclei in the cement paste. Many nuclei lead to reduced growth and result in a globular and dense C-S-H morphology. C-S-H nucleation occurring far from the interface indicates that TPM freed by siloxane crosslink dissolution diffused into the cement matrix to nucleate C-S-H.

The 2M20T gel displayed the most hydrate growth from 3-18 hours (FIGS. 22C and 23C) when compared to the 2M and 2M5T gel. C-S-H was dense and globular at all ages indicating that hydrate formation was nucleation-dominated. The high TPM loading in 2M20T led to nucleation-dominated hydrate growth that was not suppressed like the behavior seen for 2M5T.

After 21 hours both 2M5T and 2M20T displayed (FIGS. 24B and 24C) uniform growth of dense, globular C-S-H. The globular C-S-H seen with the 2M5T and 2M20T samples is morphologically like synthesized C-S-H seeds in literature and even C-S-H synthesized from alkoxysilanes.

### Example 7

### Flow Table

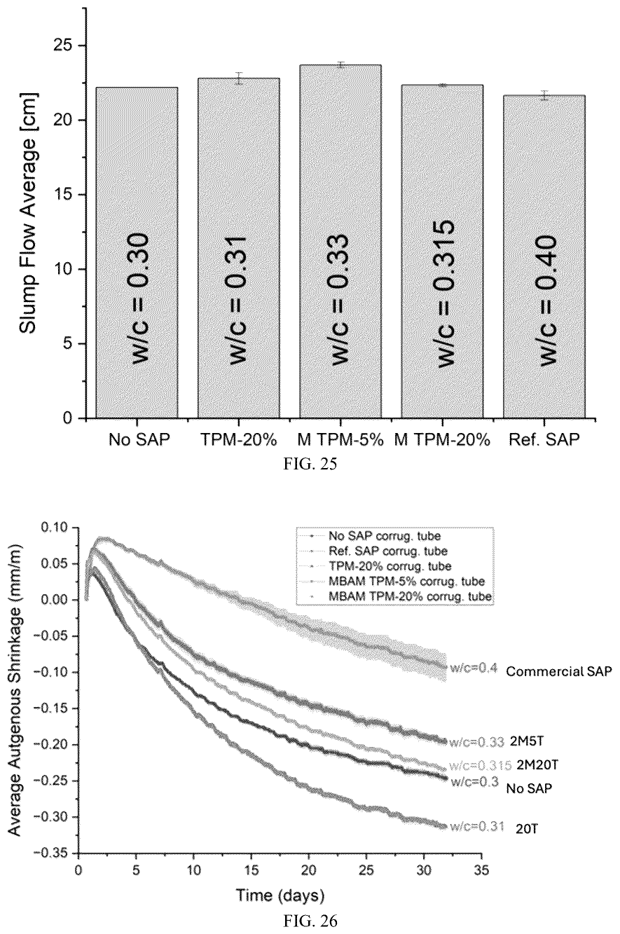

Flow table tests were performed to determine the water/cement (w/c) ratio required to maintain concrete workability across samples with no SAP or SAPs with varying absorption capacities. The mortar mix compositions are provided in Table 3. SAPs included reference/commercial SAP (FLOSET™ 27-CS, available from SNF Floerger), and exemplary composite SAPs according to the disclosure (TPM-20%, MBAM TPM-5%, and MBAM TPM-20%). The control mortar mix with no SAP had a set w/c of 0.3 and exhibited a slump flow of 22.4 cm. SAPs were loaded into mortar at a loading of 0.2% by weight of cement. W/c values for mixes with SAP were adjusted to achieve a slump flow within 1 cm of the reference mix. In the data shown in FIG. 25, the water/cement ratio (w/c) was varied.

TABLE 3
Mortar mix compositions.

| Material | Unit Mass [kg/m³] |
|---|---|
| Cement | 700 |
| Silica Fume | 70 |
| Water (w/c = 0.30) | 1218 |
| Sand | 121.8 |
| Quartz Sand | 121.8 |
| Superplasticizer | 12.6 |
| SAP (0.2% by weight of cement) | 1.4 |
| Extra Water Amounts: | |
| TPM-20% | 7 |
| MBAM TPM-5% | 21 |
| MBAM TPM-20% | 15.5 |
| Reference SAP | 70 |
| Control (No SAP) | 0 |

In a context like cement 3D printing, different amounts of water may be added to a mix to compensate for water bound in the additives (like SAPs) to maintain the slump across mixes. The extra water needed to maintain slump correlated with the swelling data of each SAP. The reference commercial SAP exhibits the highest swelling ratio and subsequently its mortar mix needed the highest w/c to maintain slump. This trend continues with the synthesized composite SAPs. For example, 2% MBAM 5% TPM had the highest swelling ratio, followed by 2% MBAM 20% TPM, and finally 20% TPM and their w/c ratios necessary to maintain slump required extra water in that order. The results validated the teabag swelling data (FIGS. 9A and 9B).

### Example 8

### Autogenous Shrinkage

Autogenous shrinkage measurements were carried out in plastic corrugated tubes in accordance with ASTM C1698 to validate the composite SAPs and internal curing agents in cementitious mixtures. Data are shown in FIG. 26.

The data shown in FIG. 26 shows autogenous shrinkage data for the composite SAPs in mortar mix with a commercially SAP as a comparison. The mortar mix compositions are provided in Table 3 of Example 7. The composite SAPs containing MBAM crosslinks along with TPM reduced the autogenous shrinkage as compared to the control. This validated the composite SAPs as internal curing agents. The 20T SAP with no MBAM exhibited the most autogenous shrinkage, providing evidence that the TPM in a gel increases the formation of C-S-H, as this would increase the autogenous shrinkage.

### Example 9

### Compression/Flexural Strength

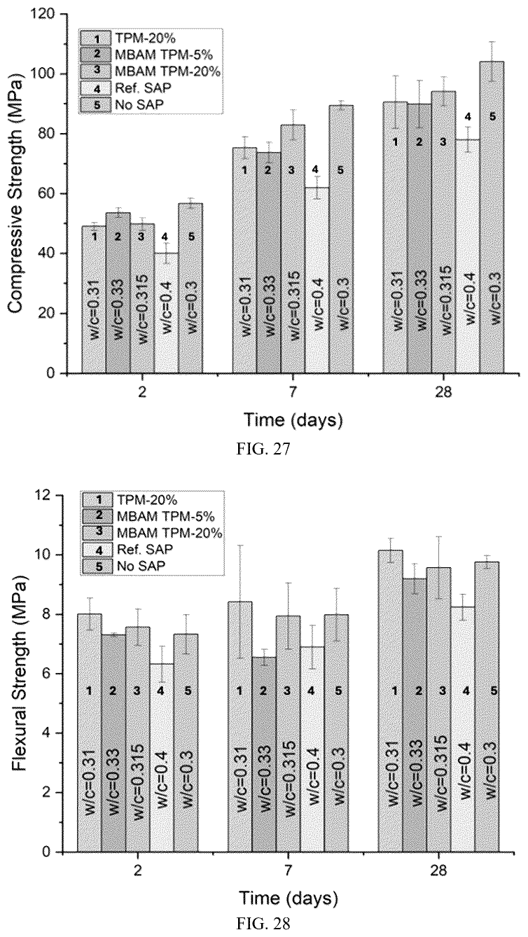

Mortar mix compositions with composite SAPs, no SAP, and a reference commercial SAP were cast and stored within a climate-controlled room. The mortar mix compositions are provided in Table 3 of Example 7. Standard compression and flexural testing methods were performed to analyze the effect of various SAP compositions on the mechanical behavior of mortar. Data are shown in FIGS. 27 and 28.

As shown in FIG. 27, for mortar mixes that varied water content to match slump, all three composite SAP containing mortars had a higher compression strength as compared to the sample with commercial SAP.

As shown in FIG. 28, in the case of flexural strength with water content varied to maintain slump across mixes, the composite SAP containing mortars maintained or improved the strength of the control mortar. Both the control mortar and composite SAP containing mortars had superior flexural strength than the commercial SAP.

### Example 10

### Concrete Mixture

Mixing is conducted using a fully automated system specifically designed to meet the demands and standards of commercial concrete production, ensuring uniformity and scalability of the mixtures. The materials that are utilized include potable water, fine aggregate (FA), coarse aggregate (maintained at saturated surface dry (SSD) condition), slag cement (grade 100), Type IL cement, and SAP particles, and air-entrainment (AE) admixture (Sika Air 260).

The concrete mixture design (CMD) is based on the Class C concrete (658 lbs·cu. yd (390 kg/m³)) as per section 702 of the Indiana Department of Transportation (INDOT) standard specifications 2024 (30).

TABLE 4
Concrete Mixture Proportions

| | | | | | organic- | |
|---|---|---|---|---|---|---|
| | | Cement | | Slag | inorganic | |
| | | (lbs./cu | FA/Total | (lbs./cu | composite | AE (fl. |
| Mixture ID | w/c | yd) | Aggr. | yd) | (pound) | oz/cwt) |
| REF | 0.44 | 658 | 0.41 | | | ~0.9 |
| REF + Slag | 0.44 | 461 | 0.41 | 197 | | ~0.8 |
| REF + SAP | 0.44 | 658 | 0.41 | | 1 | ~0.8 |
| REF + | 0.44 | 461 | 0.41 | 197 | 1 | ~0.9 |
| Slag + SAP | | | | | | |

The CMD for six concrete mixture compositions are shown in Table 4. All mixtures are batched at a constant w/c of 0.44. The reference plain mixture (REF) contains 658 lbs./cu. yd of Type 1L cement whereas the reference slag cement mixture (REF+slag) contains 30% weight replacement of cement by grade 100 slag cement. In addition, companion mixtures to both plain and slag reference mixes are also produced. These mixtures contain 0.15% organic-inorganic composite (SAP) by the weight of the cement/slag binder and are labeled as (REF+SAP) and (REF+slag+SAP).

What is claimed is:

1. A cementitious composition comprising:
(i) a cementitious material and (ii) an organic-inorganic composite,
wherein the organic-inorganic composite comprises:
an acrylic polymer;
a siloxane; and
a crosslinker comprising an acrylic group that forms a portion of the acrylic polymer and a silicon atom that forms a portion of the siloxane, wherein the crosslinker interconnects the siloxane and the acrylic polymer to form the composite.

2. The cementitious composition of claim 1, wherein the cementitious material is selected from the group consisting of cement, slag, supplementary cementitious material, and any combination thereof.

3. The cementitious composition of claim 1, wherein the crosslinker comprises a carbon-silicon bond.

4. The cementitious composition of claim 1, wherein the composite comprises an acrylic monomer comprising an acrylic group that forms a portion of the acrylic polymer.

5. The cementitious composition of claim 4, wherein the acrylic monomer is selected from the group consisting of acrylamide, methacrylamide, acrylic acid, methacrylic acid, alkyl acrylate, alkyl methacrylate, and any combination thereof.

6. The cementitious composition of claim 5, wherein the composite comprises about 50% to about 99.9% by weight of the acrylic monomer.

7. The cementitious composition of claim 1, wherein the composite comprises a bisacrylic monomer comprising two acrylic groups that each form a portion of the acrylic polymer.

8. The cementitious composition of claim 7, wherein the bisacrylic monomer is selected from the group consisting of methylenebisacrylamide (MBAM), N,N′-ethylenebisacrylamide (EBAM), N,N′-bisacryloyl cystamine (BAC), N,N′-bis(acryloyl)ethylene diamine (BAED), polyethylene glycol diacrylate (PEGDA), 1,4-butanediol diacrylate (BDDA), and any combination thereof.

9. The cementitious composition of claim 8, wherein the composite comprises about 0.1% to about 10% by weight of the bisacrylic monomer.

10. The cementitious composition of claim 1, wherein the composite comprises a crosslinking monomer comprising an acrylic group that forms a portion of the acrylic polymer and a silyl group.

11. The cementitious composition of claim 10, wherein the composite comprises about 0.1% to about 50% by weight of the crosslinker, the crosslinking monomer, or combination thereof.

12. A method of preparing the cementitious composition of claim 1 comprising:
contacting a monomer mixture with an initiator, wherein the monomer mixture comprises a crosslinking monomer and an acrylic monomer, thereby providing an organic-inorganic polymer;
and combining the organic-inorganic composite and a cementitious material.

13. The method of claim 12, wherein the cementitious material is selected from the group consisting of cement, slag, supplementary cementitious material, and any combination thereof.

14. The method of claim 12, wherein the monomer mixture comprises about 0.1% to about 50% by weight of the crosslinking monomer.

15. The method of claim 14, wherein the monomer mixture comprises about 50% to about 99.9% by weight of the acrylic monomer.

16. The method of claim 12, wherein the monomer mixture further comprises a bisacrylic monomer.

17. The method of claim 16, wherein the monomer mixture comprises about 0.1% to about 10% by weight of the bisacrylic monomer.

18. An organic-inorganic composite comprising:
an acrylic polymer;
a siloxane; and
a crosslinker comprising an acrylic group that forms a portion of the acrylic polymer and a silicon atom that forms a portion of the siloxane, wherein the crosslinker interconnects the siloxane and the acrylic polymer to form the composite.

19. The organic-inorganic composite of claim 18, wherein the acrylic polymer comprises an acrylic monomer and a bisacrylic monomer.

20. A package comprising the cementitious composition of claim 1.
